(19) United States
(12) Patent Application Publication
(10) Pub. No.: US 2020/0181435 A1
(43) Pub. Date: Jun. 11, 2020

(54) METAL DISPERSION LIQUID, IMAGE RECORDING METHOD, AND RECORDED OBJECT

(71) Applicant: FUJIFILM CORPORATION, Minato-ku (JP)

(72) Inventors: Motoi HARADA, Kanagawa (JP); Naoharu KIYOTO, Kanagawa (JP); Akira ICHIKI, Kanagawa (JP)

(21) Appl. No.: 16/794,244

(22) Filed: Feb. 19, 2020

Related U.S. Application Data
(63) Continuation of application No. PCT/JP2018/017672, filed on May 7, 2018.

(30) Foreign Application Priority Data
Aug. 21, 2017 (JP) 2017-158890

(51) Int. Cl. C09D 11/326; C09D 17/00

(52) U.S. Cl. CPC C09D 11/326; B22F 9/24; C09D 17/002; C09D 17/006

(57) ABSTRACT

Provided are a metal dispersion liquid including tabular metal particles, a water-soluble resin which contains at least one functional group selected from the group consisting of a carboxy group, an amino group, and a thiol group, a polycarboxylic acid having a partial structure which connects carbon atoms in two carboxy groups to each other and has four or more linearly bonded atoms, or a salt thereof, and water; and applications thereof.

### CROSS-REFERENCE TO RELATED APPLICATIONS

This application is a continuation application of International Application No. PCT/JP2018/017672, filed May 7, 2018, the disclosure of which is incorporated herein by reference in its entirety. Further, this application claims priority from Japanese Patent Application No. 2017-158890, filed Aug. 21, 2017, the disclosure of which is incorporated herein by reference in its entirety.

### BACKGROUND OF THE INVENTION

### 1. Field of the Invention

The present disclosure relates to a metal dispersion liquid, an image recording method, and a recorded object.

### 2. Description of the Related Art

In the related art, a metal dispersion liquid used for forming a film having a light-shielding property, a heat-shielding property, and the like has been known.

For example, as a metal fine particle-containing composition which has excellent heat resistance and in which a change in the particle size, the shape, or the like of metal fine particles due to a heat treatment is suppressed even in a case where the composition contains metal fine particles having a particle size that causes melting point depression, a metal fine particle-containing composition which contains metal fine particles and a heterocyclic compound containing at least one sulfur atom has been known (for example, see JP2008-001844A).

### SUMMARY OF THE INVENTION

In addition, a metal dispersion liquid containing metal particles is required to exhibit physical properties (so-called “thixotropy”, hereinafter, also referred to as “thixotropic properties”) of having a moderate viscosity which is not extremely high at the time of moving and rapidly thickening at the time of standing still in some cases.

For example, in a case where a metal dispersion liquid containing metal particles is used for forming a coated film, from the viewpoint of coating properties, it is desirable that the metal dispersion liquid before being applied to a base material has a moderate viscosity which is not extremely high. In addition, from the viewpoint of suppressing liquid dripping, it is desirable that the metal dispersion liquid after being applied to the base material is rapidly thickened.

For example, in a case where the metal dispersion liquid containing metal particles is used for image recording according to an ink jet method, from the viewpoint of the jettability from a nozzle of an ink jet head, it is desirable that the metal dispersion liquid before being applied to the base material has a moderate viscosity which is not extremely high. In addition, from the viewpoint of suppressing degradation of sharpness of a recorded image due to spread of liquid droplets, landing interference, and the like, it is desirable that the metal dispersion liquid after being applied to the base material is rapidly thickened.

An object of an embodiment of the present invention is to provide a metal dispersion liquid having thixotropic properties.

Further, an object of another embodiment of the present invention is to provide an image recording method that enables recording of a sharp image.

Further, an object of still another embodiment of the present invention is to provide a recorded object comprising a sharp image.

Means for achieving the above-described objects includes the following aspects.

<1> A metal dispersion liquid comprising: tabular metal particles; a water-soluble resin which contains at least one functional group selected from the group consisting of a carboxy group, an amino group, and a thiol group; a polycarboxylic acid having a partial structure which connects carbon atoms in two carboxy groups to each other and has four or more linearly bonded atoms, or a salt thereof; and water.

<2> The metal dispersion liquid according to <1>, in which the tabular metal particles contain at least one metal element selected from the group consisting of silver, gold, and platinum.

<3> The metal dispersion liquid according to <1> or <2>, in which the tabular metal particles contain silver.

<4> The metal dispersion liquid according to any one of <1> to <3>, in which the tabular metal particles have an average aspect ratio of 5 to 100, which is a ratio of an average equivalent circle diameter to an average thickness.

<5> The metal dispersion liquid according to any one of <1> to <4>, in which the tabular metal particles have an average aspect ratio of 12 to 100, which is the ratio of the average equivalent circle diameter to the average thickness.

<6> The metal dispersion liquid according to any one of <1> to <5>, in which the tabular metal particles have an average aspect ratio of 20 to 100, which is the ratio of the average equivalent circle diameter to the average thickness.

<7> The metal dispersion liquid according to any one of <1> to <6>, in which a molecular weight of the polycarboxylic acid or the salt thereof is 120 or greater in terms of the polycarboxylic acid.

<8> The metal dispersion liquid according to any one of <1> to <7>, in which the molecular weight of the polycarboxylic acid or the salt thereof is 160 or greater in terms of the polycarboxylic acid.

<9> The metal dispersion liquid according to any one of <1> to <8>, in which the molecular weight of the polycarboxylic acid or the salt thereof is 180 or greater in terms of the polycarboxylic acid.

<10> The metal dispersion liquid according to any one of <1> to <9>, in which a content of the polycarboxylic acid or the salt thereof is in a range of 0.001% by mass to 15% by mass with respect to a total amount of the tabular metal particles in terms of the polycarboxylic acid.

<11> The metal dispersion liquid according to any one of <1> to <10>, in which an average equivalent circle diameter of the tabular metal particles is in a range of 50 nm to 600 nm.

<12> The metal dispersion liquid according to any one of <1> to <11>, in which a content of the water-soluble resin is in a range of 0.1% by mass to 30% by mass with respect to the total amount of the tabular metal particles.

<13> The metal dispersion liquid according to any one of <1> to <12>, in which the content of the polycarboxylic acid or the salt thereof is in a range of 0.001% by mass to 10% by mass with respect to the total amount of the tabular metal particles in terms of the polycarboxylic acid.

<14> The metal dispersion liquid according to any one of <1> to <13>, which is used as an ink.

<15> The metal dispersion liquid according to <14>, which is used for ink jet recording.

<16> An image recording method comprising: a step of applying the metal dispersion liquid according to any one of <1> to <15> onto a base material using an ink jet method.

<17> A recorded object comprising: a base material; and an image which is disposed on the base material and contains tabular metal particles and a water-soluble resin containing at least one functional group selected from the group consisting of a carboxy group, an amino group, and a thiol group, in which at least one of the base material or the image contains a polycarboxylic acid having a partial structure which connects carbon atoms in two carboxy groups to each other and has four or more linearly bonded atoms, or a salt thereof.

According to an embodiment of the present invention, it is possible to provide a metal dispersion liquid having thixotropic properties.

Further, according to another embodiment of the present invention, it is possible to provide an image recording method that enables recording of a sharp image.

Further, according to still another embodiment of the present invention, it is possible to provide a recorded object comprising a sharp image.

### BRIEF DESCRIPTION OF THE DRAWINGS

FIG. 1 is a view showing a character image used for evaluating the sharpness of an image in examples.

### DESCRIPTION OF THE PREFERRED EMBODIMENTS

Hereinafter, examples embodiments of a metal dispersion liquid, an image recording method, and a recorded object, to which the present invention has been applied, will be described. However, the present invention is not limited to the following embodiments, and modifications can be made as appropriate within the range of the purpose of the present invention.

Further, the numerical ranges shown using “to” in the present disclosure indicate ranges including the numerical values described before and after “to” as the minimum values and the maximum values.

In the numerical ranges described in a stepwise manner in the present disclosure, the upper limits or the lower limits described in certain numerical ranges may be replaced with the upper limits or the lower limits in other numerical ranges described in a stepwise manner. Further, in the numerical ranges described in the present specification, the upper limits or the lower limits described in certain numerical ranges may be replaced with values described in examples.

In the present disclosure, combinations of two or more preferable aspects are more preferable aspects.

In the present disclosure, the amount of each component indicates the total amount of a plurality of kinds of materials in a case where a plurality of kinds of materials are present in the corresponding component.

In the present disclosure, the “steps” include not only independent steps but also steps whose intended purposes are achieved even in a case where the steps cannot be precisely distinguished from other steps.

In the present disclosure, the concept of “light” includes active energy rays such as γ rays, β rays, electron beams, ultraviolet rays, visible rays, and infrared rays.

The “average aspect ratio” of the tabular metal particles in the present disclosure indicates the ratio [average equivalent circle diameter/average thickness] of the average equivalent circle diameter to the average thickness in the tabular metal particles.

The methods of acquiring the average thickness, the average equivalent circle diameter, and the average aspect ratio will be described below.

The “specular glossiness” of a film (for example, an image) in the present disclosure indicates glossiness high enough to reflect an object facing the film (for example, an image) and is distinguished from simple metal gloss (for example, see “evaluation standards for “(2) sensory evaluation” of “3. specular glossiness of image” in examples described below).

In the present disclosure, the “specular glossiness” of a film (for example, an image) is evaluated based on the 20° gloss value and the sensory evaluation (so-called visual observation).

As the numerical value of the 20° gloss value is increased, this indicates that the specular glossiness of an image is excellent.

In the present disclosure, the “tint” of a film (for example, an image) is evaluated based on the metric saturation value. As the metric saturation number is decreased, this indicates that the tint of a film (for example, an image) image is suppressed. Further, the state in which “the tint is suppressed” indicates that absorption of light having a specific wavelength in a visible range due to metal particles is suppressed so that the film has a neutral tint.

[Metal Dispersion Liquid]

A metal dispersion liquid according to the embodiment of the present disclosure is a metal dispersion liquid which includes tabular metal particles, a water-soluble resin (hereinafter, also referred to as a “specific water-soluble resin”) that contains at least one functional group (hereinafter, also referred to as a “specific functional group”) selected from the group consisting of a carboxy group, an amino group, and a thiol group, a polycarboxylic acid (hereinafter, also referred to as a “specific polycarboxylic acid”) having a partial structure which connects carbon atoms in two carboxy groups to each other and has four or more linearly bonded atoms, or a salt thereof, and water.

Hereinafter, in the present disclosure, the “specific polycarboxylic acid or the salt thereof” are collectively referred to as “a specific polycarboxylic acid or the like” in some cases.

The metal dispersion liquid according to the embodiment of the present disclosure has physical properties (so-called “thixotropic properties”) of having a moderate viscosity which is not extremely high at the time of moving and rapidly thickening at the time of standing still.

The reason why the metal dispersion liquid according to the embodiment of the present disclosure has such effects is not clear, but the present inventors assumed as follows.

Since the metal dispersion liquid according to the embodiment of the present disclosure contains tabular metal particles and a polycarboxylic acid having a partial structure which connects carbon atoms in two carboxy groups to each other and has four or more linearly bonded atoms, or a salt thereof (that is, a specific polycarboxylic acid or the like), one carboxy group such as the specific polycarboxylic acid is adsorbed on the surface of the tabular metal particle and another carboxy group is adsorbed on the surface of another tabular metal particle. Therefore, a structure in which tabular metal particles are connected through the specific polycarboxylic acid or the like is formed. Further, since the metal dispersion liquid according to the embodiment of the present disclosure contains a water-soluble resin (that is, a specific water-soluble resin) which contains the specific polycarboxylic acid or the like and at least one functional group (that is, a specific functional group) selected from the group consisting of a carboxy group, an amino group, and a thiol group, the carboxy group such as the specific polycarboxylic acid or the like interacts with the specific functional group of the specific water-soluble resin, and thus the specific polycarboxylic acid or the like is connected to the specific water-soluble resin in some cases. Accordingly, the metal dispersion liquid according to the embodiment of the present disclosure is considered to exhibit a moderately high viscosity in a state of standing still.

Meanwhile, since the adsorption of the carboxy group such as the specific polycarboxylic acid or the like on the surface of the tabular metal particle is not so strong, the carboxy group of the specific polycarboxylic acid or the like is desorbed from the surface of the tabular metal particle in a case where the metal dispersion liquid is allowed to flow. Further, since the interaction between the carboxy group of the specific polycarboxylic acid or the like and the specific functional group of the specific water-soluble resin is also not so strong, the connection of the specific polycarboxylic acid or the like with the specific water-soluble resin is eliminated in the case where the metal dispersion liquid is allowed to flow. Therefore, the viscosity of the metal dispersion liquid according to the embodiment of the present disclosure is considered to decrease due to the flow.

In contrast to the metal dispersion liquid according to the embodiment of the present disclosure, the metal fine particle-containing composition described in JP2008-001844A does not contain the specific polycarboxylic acid or the like. Therefore, it is considered that such thixotropic properties of the metal dispersion liquid according to the embodiment of the present disclosure cannot be obtained in a case of using the metal fine particle-containing composition JP2008-001844A is considered.

According to the metal dispersion liquid according to the embodiment of the present disclosure, a sharp image can be recorded.

For example, in a case where the metal dispersion liquid according to the embodiment of the present disclosure is used for image recording according to an ink jet method, since the metal dispersion liquid is rapidly thickened after being applied onto a base material, degradation of sharpness of a recorded image due to spread of liquid droplets, landing interference, and the like is unlikely to occur.

The metal dispersion liquid according to the embodiment of the present disclosure contains tabular metal particles as metal particles, and thus a film having specular glossiness can be formed.

For example, in a case where the shape of the metal particle is a shape other than the tabular shape such as a sphere or a cube, the specular glossiness of a film is considered to be degraded because of the impact of light scattering on the surface of the metal particle even in a case where a film having metal glossiness is obtained. Further, metal particles having shapes other than the tabular shape tend to have a low aspect ratio and absorb light having a specific wavelength in a visible light range. Therefore, these metal particles are likely to be tinted.

In addition, the above-described assumption is not intended to limitatively interpret the effects of the present invention, but explains the mechanism as an example.

Hereinafter, each component in the metal dispersion liquid according to the embodiment of the present disclosure will be described in detail.

[Tabular Metal Particles]

The metal dispersion liquid according to the embodiment of the present disclosure contains tabular metal particles.

In the present disclosure, the term “tabular” indicates the shape of a particle with two main planes.

The shape of the tabular metal particles is not particularly limited as long as each particle is tabular, in other words, each particle has two main planes, and the shape thereof can be appropriately selected depending on the purpose thereof.

Examples of the shape of the tabular metal particles include a triangular shape, a square shape, a hexagonal shape, an octagonal shape, and a circular shape.

As the shape of the tabular metal particles, from the viewpoint of a low absorbance in a visible light range, a triangular or higher polygonal shape and a circular shape (hereinafter, also referred to as “triangular to circular shapes”) are preferable.

The circular shape is not particularly limited as long as the tabular metal particle has a round shape without corners in a case where the particle is observed in the normal direction of the main plane using a transmission electron microscope (TEM), and can be appropriately selected depending on the purpose thereof.

The triangular or higher polygonal shape is not particularly limited as long as the tabular metal particle has a triangular or higher polygonal shape in a case where the particle is observed in the normal direction of the main plane using a transmission electron microscope (TEM), and can be appropriately selected depending on the purpose thereof.

The angle of the triangular or higher polygonal shape may be an acute angle or an obtuse angle, but an obtuse angle is preferable from the viewpoint that absorption of light in a visible light range can be reduced.

The proportion of the tabular metal particles having triangular to circular shapes in the tabular metal particles is preferably 60% by number or greater, more preferably 65% by number or greater, and still more preferably 70% by number or greater with respect to the total number of tabular metal particles.

In a case where the proportion of the tabular metal particles having triangular to circular shapes is 60% by number or greater, the absorbance of light in a visible light range is further decreased.

The term “% by number” indicates the proportion (so-called percentage) of the number of tabular metal particles having triangular to circular shapes in 500 pieces of tabular metal particles. The “% by number” is acquired by observing 500 pieces of tabular metal particles in the normal direction of the main planes using a TEM.

The average equivalent circle diameter of the tabular metal particles is not particularly limited.

The average equivalent circle diameter of the tabular metal particles is preferably in a range of 50 nm to 1000 nm, more preferably in a range of 50 nm to 600 nm, and still more preferably in a range of 100 nm to 400 nm.

In a case where the average equivalent circle diameter of the tabular metal particles is 50 nm or greater, since the absorbance of light in a visible light range is further decreased, a film with a suppressed tint can be formed. Further, in a case where the absorbance of light in a visible light range is further decreased, a film with excellent specular glossiness can be formed.

In a case where the average equivalent circle diameter of the tabular metal particles is 1000 nm or less, the dispersibility of the tabular metal particles in the metal dispersion liquid is further improved, and thus a film with excellent specular glossiness can be formed. Further, in a case where the metal dispersion liquid is used as an ink for ink jet recording, clogging of a nozzle of an ink jet head is further suppressed, and thus the jettability can be further improved.

In the present disclosure, the “average equivalent circle diameter of the tabular metal particles” indicates the number average value of the equivalent circle diameters of 500 pieces of tabular metal particles.

The equivalent circle diameter of each tabular metal particle is acquired based on a transmission electron microscope image (TEM image). Specifically, the diameter of a circle having the same area as the area (that is, the projected area) of the tabular metal particle in a TEM image is set as the equivalent circle diameter.

The example of the method of measuring the average equivalent circle diameter of the tabular metal particles is as described in the examples below.

The coefficient of variation in the particle size distribution of the tabular metal particles is preferably 35% or less, more preferably 30% or less, and still more preferably 20% or less.

The “coefficient of variation in the particle size distribution of the tabular metal particles” indicates a value (%) obtained by dividing the standard deviation of the equivalent circle diameters (particle size distribution) of 500 pieces of tabular metal particles by the number average value (that is, the average equivalent circle diameter) of the equivalent circle diameters of 500 pieces of tabular metal particles and multiplying the divided value by 100.

From the viewpoints of the dispersibility of the tabular metal particles in the metal dispersion liquid and the jettability of the metal dispersion liquid in a case of being used as an ink for ink jet recording, the average thickness of the tabular metal particles is preferably 50 nm or less, more preferably in a range of 2 nm to 25 nm, and still more preferably in a range of 3 nm to 15 nm.

In the present disclosure, the “average thickness of the tabular metal particles” indicates the number average value of the thicknesses of 500 pieces of the tabular metal particles.

The thickness of each tabular metal particle is measured according to a focused ion beam-transmission electron microscopy (FIB-TEM) method.

The example of the method of measuring the average thickness of the tabular metal particles is as described in the examples below.

The average aspect ratio (that is, average equivalent circle diameter/average thickness) of the tabular metal particles is not particularly limited.

The average aspect ratio of the tabular metal particles is preferably in a range of 5 to 100, more preferably in a range of 12 to 100, and still more preferably in a range of 20 to 100.

In a case where the average aspect ratio of the tabular metal particles is 5 or greater, since the absorbance of light in a visible light range is further decreased, a film with a suppressed tint can be formed. Further, in a case where the absorbance of light in a visible light range is further decreased, a film with excellent specular glossiness can be formed.

In a case where the average aspect ratio of the tabular metal particles is 100 or less, the dispersibility of the tabular metal particles in the metal dispersion liquid is further improved, and thus a film with excellent specular glossiness can be formed.

The metal element contained in the tabular metal particles is not particularly limited, and examples thereof include metal elements such as silver, gold, platinum, and aluminum.

From the viewpoint of the specular glossiness of a film (for example, an image), the tabular metal particles contain preferably at least one metal element selected from the group consisting of silver, gold, or platinum, more preferably at least one metal element selected from silver or gold, and still more preferably silver.

Further, from the viewpoint of suppressing the tint of a film (for example, an image), the tabular metal particles contain preferably at least one metal element selected from silver or platinum and more preferably silver.

For example, from the viewpoint of further improving the specular glossiness of a film (for example, an image), the content of the silver in the tabular metal particles is preferably 80% by mass or greater and more preferably 90% by mass or greater with respect to the total amount of the tabular metal particles. The upper limit thereof is not particularly limited, but is typically 100% by mass or less.

The metal dispersion liquid according to the embodiment of the present disclosure may contain one or two or more kinds of tabular metal particles.

The content of the tabular metal particles in the metal dispersion liquid according to the embodiment of the present disclosure is not particularly limited.

The content of the tabular metal particles in the metal dispersion liquid according to the embodiment of the present disclosure is preferably in a range of 0.1% by mass to 50% by mass, more preferably in a range of 0.1% by mass to 40% by mass, and still more preferably in a range of 0.1% by mass to 30% by mass with respect to the total amount of the metal dispersion liquid.

In a case where the content of the tabular metal particles in the metal dispersion liquid according to the embodiment of the present disclosure is 0.1% by mass or greater with respect to the total amount of the metal dispersion liquid, the specular glossiness of the film is further improved.

In a case where the content of the tabular metal particles in the metal dispersion liquid according to the embodiment of the present disclosure is 50% by mass or less with respect to the total amount of the metal dispersion liquid, the jettability in the case where the metal dispersion liquid is used as an ink for ink jet recording can be further improved.

˜Method of Synthesizing Tabular Metal Particles˜

A method of synthesizing the tabular metal particles is not particularly limited and can be appropriately selected depending on the purpose thereof.

Examples of the method of synthesizing the tabular metal particles having a triangular or higher polygonal shape include liquid phase methods such as a chemical reduction method, a photochemical reduction method, and an electrochemical reduction method.

Among these, as the method of synthesizing the tabular metal particles having a triangular or higher polygonal shape, from the viewpoint of controlling the shape and the size, a chemical reduction method or a photochemical reduction method is preferable.

In a case where the tabular metal particles having a triangular or higher polygonal shape are synthesized, the corners of each tabular metal particle having a triangular or higher polygonal shape may be made blunt by performing an etching treatment using a dissolution species that dissolves silver, such as nitric acid or sodium nitrite, and an aging treatment through heating after the synthesis.

As the method of synthesizing the tabular metal particles, a method of fixing a seed crystal onto a surface of a transparent base material such as a film or glass in advance and then allowing crystals of the metal particles (for example, Ag) to grow in a tabular shape may be used in addition to the synthesis method described above.

The method of synthesizing the tabular metal particles can refer to the description in paragraphs [0041] to [0053] of JP2014-070246A.

The tabular metal particles may be subjected to another treatment in order to impart desired characteristics.

Another treatment is not particularly limited and can be appropriately selected depending on the purpose thereof.

Examples of another treatment include a treatment of forming a high refractive index shell layer described in paragraphs [0068] to [0070] of JP2014-184688A and a treatment of adding various additives described in paragraphs [0072] and [0073] of JP2014-184688A.

[Specific Water-Soluble Resin]

The metal dispersion liquid according to the embodiment of the present disclosure contains a water-soluble resin (that is, a specific water-soluble resin) containing at least one functional group (that is, a specific functional group) selected from the group consisting of a carboxy group, an amino group, and a thiol group.

In the metal dispersion liquid according to the embodiment of the present disclosure, the specific water-soluble resin can function as a dispersant.

Further, the term “water-soluble” in the water-soluble resin indicates a property in which 5 g or greater (preferably 10 g or greater) of a substance is dissolved in 100 g of water at 25° C.

The specific water-soluble resin is not particularly limited as long as the water-soluble resin contains a specific functional group.

The specific water-soluble resin may contain only one or two or more kinds of specific functional groups.

The amino group which is a specific functional group may be a primary amino group, a secondary amino group, or a tertiary amino group.

It is preferable that the specific water-soluble resin contains at least one of a carboxy group or an amino group.

In a case where the specific water-soluble resin contains at least one of a carboxy group or an amino group, the thixotropic properties of the metal dispersion liquid are easily obtained. Further, an image with a sharper image quality can be recorded.

In other words, the carboxy group and the amino group contained in the specific water-soluble resin are adsorbed on each surface of the tabular metal particles, and thus can function as a dispersant that disperses the tabular metal particles and interacts with the carboxy group contained in the specific polycarboxylic acid or the like described below. In a case where at least one of the carboxy group or the amino group contained in the specific water-soluble resin interacts with the carboxy group contained in the specific polycarboxylic acid or the like, since the specific polycarboxylic acid or the like is connected with the specific water-soluble resin, the viscosity of the metal dispersion liquid increases in a case of standing still. Therefore, it is considered that a sharper image can be recorded as the result of suppression of spread of liquid droplets and suppression of occurrence of landing interference or the like on the base material.

In addition, since the interaction between at least one of the carboxy group or the amino group contained in the specific water-soluble resin and the carboxy group in the specific polycarboxylic acid or the like is not so strong, the connection between the specific water-soluble resin and the specific polycarboxylic acid or the like is eliminated in a case where the metal dispersion liquid is allowed to flow, and the viscosity of the metal dispersion liquid is rapidly decreased.

For the reason described above, the thixotropic properties of the metal dispersion liquid are considered to be easily obtained in a case where the specific water-soluble resin contains at least one of the carboxy group or the amino group.

Examples of the specific water-soluble resin include gelatin, polyethyleneimine, polyvinylpyrrolidone (PVP), and polyacrylic acid.

Among these, gelatin is particularly preferable as the specific water-soluble resin.

Since gelatin contains all specific functional groups such as a carboxy group, an amino group, and a thiol group, a pseudo crosslinked structure formed with the tabular metal particles and the specific polycarboxylic acid or the like is easily obtained. Therefore, since the metal dispersion liquid according to the embodiment of the present disclosure contains gelatin, the thixotropic properties are likely to be obtained.

Further, since the metal dispersion liquid according to the embodiment of the present disclosure contains gelatin, the dispersibility of the tabular metal particles can be improved. In a case where the dispersibility of the tabular metal particles is improved, the specular glossiness of the film to be formed is expected to be improved. Further, in the case where the dispersibility of the tabular metal particles is improved, the jettability of the metal dispersion liquid from a nozzle of an ink jet head can be improved at the time of using the metal dispersion liquid for image recording according to an ink jet method.

Particularly in a case where the tabular metal particles contain silver and gelatin is selected as a specific water-soluble resin, since the tabular metal particles can be satisfactorily dispersed in the metal dispersion liquid at a high concentration, the specular glossiness of the image can be further improved.

Examples of the gelatin include alkali-treated gelatin accompanied by a treatment using an alkali such as lime in the process of induction from collagen; acid-treated gelatin accompanied by a treatment using an acid such as hydrochloric acid; enzyme-treated gelatin accompanied by a treatment using an enzyme such as an hydrolytic enzyme; oxygen-treated gelatin; modified gelatin (such as phthalated gelatin, succinated gelatin, or trimellitic gelatin) modified by a reagent containing one group which is capable of reacting an amino group, an imino group, a hydroxy group, or a carboxy group serving as a functional group contained in a gelatin molecule with these functional groups; and gelatin which has been typically used in the related art described from the 6-th line of the column lower left in page 222 to the last line of the column upper left in page 225 of JP1987-215272A (JP-S62-215272A).

From the viewpoint of the dispersibility of the tabular metal particles, the weight-average molecular weight of the specific water-soluble resin is preferably in a range of 5000 to 1000000, more preferably in a range of 10000 to 500000, and still more preferably in a range of 20000 to 200000.

In the present disclosure, the weight-average molecular weight indicates a value measured by gel permeation chromatography (GPC).

According to GPC, the weight-average molecular weight is measured using HLC-8020GPC (manufactured by Tosoh Corporation) as a measuring device, three columns of TSKgel (registered trademark), Super Multipore HZ-H (manufactured by Tosoh Corporation, 4.6 mmID×15 cm), and tetrahydrofuran (THF) as an eluent. Further, according to GPC, the weight-average molecular weight is measured by setting the sample concentration to 0.45% by mass, the flow rate to 0.35 mL/min, the sample injection amount of 10 μL, and the measurement temperature of 40° C. using a differential refractive index (RI) detector. The calibration curve is prepared from eight “standard samples TSK standard, polystyrene” (manufactured by Tosoh Corporation): “F-40”, “F-20”, “F-4”, “F-1”, “A-5000”, “A-2500”, “A-1000”, and “n-propylbenzene”.

In a case where the metal dispersion liquid according to the embodiment of the present disclosure contains the specific water-soluble resin, the metal dispersion liquid may contain only one or two or more kinds of specific water-soluble resins.

The content of the specific water-soluble resin in the metal dispersion liquid according to the embodiment of the present disclosure is not particularly limited.

The content of the specific water-soluble resin in the metal dispersion liquid according to the embodiment of the present disclosure is preferably in a range of 0.1% by mass to 40% by mass, more preferably in a range of 0.1% by mass to 30% by mass, and still more preferably in a range of 0.1% by mass to 20% by mass with respect to the total amount of the tabular metal particles.

In a case where the content of the specific water-soluble resin (preferably gelatin) in the metal dispersion liquid according to the embodiment of the present disclosure is 0.1% by mass or greater with respect to the total amount of the tabular metal particles, the effect obtained by containing the specific water-soluble resin, that is, the thixotropic properties of the metal dispersion liquid can be satisfactorily exhibited. Further, since the thixotropic properties of the metal dispersion liquid are satisfactorily exhibited, a sharper image can be recorded.

In a case where the content of the specific water-soluble resin (particularly gelatin) in the metal dispersion liquid is extremely high, the specular glossiness of the film to be formed is degraded in some cases. In a case where the content of the specific water-soluble resin in the metal dispersion liquid is 40% by mass or less with respect to the total amount of the tabular metal particles, the specular glossiness of the film to be formed is unlikely to be degraded.

[Specific Polycarboxylic Acid or the Like]

The metal dispersion liquid according to the embodiment of the present disclosure contains a polycarboxylic acid having a partial structure which connects carbon atoms in two carboxy groups to each other and has four or more linearly bonded atoms, or a salt thereof (that is, the specific polycarboxylic acid or the like).

The partial structure which connects carbon atoms in two carboxy groups to each other is a partial structure which has four or more linearly bonded atoms, preferably a partial structure which has five or more linearly bonded atoms, and more preferably a partial structure which has seven or more linearly bonded atoms.

Since the polycarboxylic acid whose partial structure that connects carbon atoms in two carboxy groups to each other is a partial structure which has four or more linearly bonded atoms, or the salt thereof has a structure with a high degree of freedom and easily interacts with at least one of the tabular metal particles or the specific water-soluble resin, the thixotropic properties of the metal dispersion liquid can be satisfactorily exhibited. Further, since the thixotropic properties of the metal dispersion liquid can be satisfactorily exhibited, a sharp image can be recorded.

The upper limit of the number of linearly bonded atoms is not particularly limited, but is preferably 12 or less from the viewpoint of the water solubility.

The kind of the linearly bonded atoms is not particularly limited.

Examples of the kind of the linearly bonded atoms include a carbon atom, a nitrogen atom, and an oxygen atom.

Among these, from the viewpoint of a high degree of freedom in molecular design, the carbon atom is preferable as the kind of the linearly bonded atoms.

Examples of the “salt” as the salt of the specific polycarboxylic acid include an alkali metal salt (a sodium salt, a potassium salt, or the like).

The molecular weight of the specific polycarboxylic acid or the like is not particularly limited.

The molecular weight of the specific polycarboxylic acid or the like is preferably 120 or greater, more preferably 160 or greater, and still more preferably 180 or greater in terms of the specific polycarboxylic acid.

In a case where the molecular weight of the specific polycarboxylic acid or the like is 120 or greater in terms of the specific polycarboxylic acid, the degree of freedom of the structure increases, and the specific polycarboxylic acid or the like easily interacts with at least one of the tabular metal particles or the specific water-soluble resin. Therefore, the thixotropic properties of the metal dispersion liquid can be satisfactorily exhibited. Further, since the thixotropic properties of the metal dispersion liquid are satisfactorily exhibited, a sharper image can be recorded.

Further, the molecular weight of the specific polycarboxylic acid or the like is preferably 3000 or less, more preferably 2000 or less, and still more preferably 1000 or less in terms of the specific polycarboxylic acid.

In a case where the molecular weight of the specific polycarboxylic acid or the like is 3000 or less in terms of the specific polycarboxylic acid, a moderate viscosity can be designed without thickening of the metal dispersion liquid.

In the present disclosure, the expression “in terms of the specific polycarboxylic acid” indicates that the mass of the specific polycarboxylic acid itself is employed in a case of the specific polycarboxylic acid and the mass of the corresponding specific polycarboxylic acid that does not form the salt is employed in a case of the salt of the specific polycarboxylic acid. For example, in a case of disodium azelaic acid, the mass of azelaic acid is employed.

Examples of the specific polycarboxylic acid include adipic acid (number of atoms: 4, molecular weight: 146), pimelic acid (number of atoms: 5, molecular weight: 160), suberic acid (number of atoms: 6, molecular weight: 174), azelaic acid (number of atoms: 7, molecular weight: 188), sebacic acid (number of atoms: 8, molecular weight: 202), terephthalic acid (number of atoms: 4, molecular weight: 166), undecanedioic acid (number of atoms: 9, molecular weight: 216), dodecanedioic acid (number of atoms: 10, molecular weight: 230), tridecanedioic acid (number of atoms: 11, molecular weight: 244), and tetradecanedioic acid (number of atoms: 12, molecular weight: 258). Further, the “number of atoms” in parentheses indicates the number of linearly bonded atoms in the partial structure that connects carbon atoms in two carboxy groups contained in the specific polycarboxylic acid or the like.

Among the examples, as the specific polycarboxylic acid or the like, at least one selected from azelaic acid and sebacic acid is preferable from the viewpoint of the thixotropic properties and azelaic acid is more preferable from the viewpoint of the handleability.

In a case where the metal dispersion liquid according to the embodiment of the present disclosure contains the specific polycarboxylic acid or the like, the metal dispersion liquid may contain only one or two or more kinds of specific polycarboxylic acids.

The content of the specific polycarboxylic acid or the like in the metal dispersion liquid according to the embodiment of the present disclosure is not particularly limited.

The content of the specific polycarboxylic acid or the like in the metal dispersion liquid according to the embodiment of the present disclosure is preferably in a range of 0.001% by mass to 50% by mass, more preferably in a range of 0.001% by mass to 15% by mass, and still more preferably in a range of 0.001% by mass to 10% by mass with respect to the total amount of the tabular metal particles in terms of the specific polycarboxylic acid.

In a case where the content of the specific polycarboxylic acid or the like in the metal dispersion liquid according to the embodiment of the present disclosure is 0.001% by mass or greater with respect to the total amount of the tabular metal particles in terms of the specific polycarboxylic acid, the effect obtained by containing the specific water-soluble resin, that is, the thixotropic properties of the metal dispersion liquid can be satisfactorily exhibited. Further, since the thixotropic properties of the metal dispersion liquid are satisfactorily exhibited, a sharper image can be recorded.

In a case where the content of the specific polycarboxylic acid or the like in the metal dispersion liquid according to the embodiment of the present disclosure is 50% by mass or less with respect to the total amount of the tabular metal particles in terms of the specific polycarboxylic acid, the specular glossiness is unlikely to be degraded.

—Method of Detecting Specific Polycarboxylic Acid or the Like—

Most of the specific polycarboxylic acid or the like in the metal dispersion liquid according to the embodiment of the present disclosure is considered to be present in a state of being adsorbed on the surface of the tabular metal particle or in a state of interacting with the specific water-soluble resin.

The specific polycarboxylic acid or the like contained in the metal dispersion liquid according to the embodiment of the present disclosure can be detected according to the following method.

In order to allow the specific polycarboxylic acid or the like which has been adsorbed on the surface of the tabular metal particle to be desorbed from the surface of the tabular metal particle, the metal dispersion liquid to be measured is added to a bleach fixing agent for color paper processing (CP-48S P2 K Part A and CP-48S P2 K Part B, manufactured by Fujifilm Corporation) so that the tabular metal particles are eluted. Next, the resultant is diluted with pure water to obtain a liquid containing the specific polycarboxylic acid or the like and the specific water-soluble resin. In addition, quantification is performed by extracting the obtained liquid containing the specific polycarboxylic acid or the like according to the ion chromatography using a sample. Further, the isolated material extracted through a column is identified by at least one or nuclear magnetic resonance (NMR) or mass spectrometry (MS) as necessary.

In a case where the tabular metal particle is gold, the quantification and identification are performed according to the ion chromatography in the same manner as described above after neutralization with sodium hydroxide or the like, using aqua regia in place of the bleach fixing agent for color paper processing.

[Water]

The metal dispersion liquid according to the embodiment of the present disclosure contains water.

The metal dispersion liquid according to the embodiment of the present disclosure contains water, and thus the handleability becomes excellent. Further, a load on the environment is reduced compared to a case where the metal dispersion liquid contains an organic solvent in place of water.

The content of water in the metal dispersion liquid according to the embodiment of the present disclosure is not particularly limited.

From the viewpoints of improving the handleability of the metal dispersion liquid and reducing the environmental load, the content of water in the metal dispersion liquid according to the embodiment of the present disclosure is preferably 10% by mass or greater, more preferably 20% by mass or greater, and still more preferably 30% by mass or greater with respect to the total amount of the metal dispersion liquid.

Further, from the viewpoint of the jettability of the metal dispersion liquid in the case where the metal dispersion liquid is used as an ink for ink jet recording, the content of water in the metal dispersion liquid according to the embodiment of the present disclosure is preferably 90% by mass or less, more preferably 80% by mass or less, and still more preferably 75% by mass or less with respect to the total amount of the metal dispersion liquid.

[Organic Solvent]

The metal dispersion liquid according to the embodiment of the present disclosure contains an organic solvent.

For example, in a case where the metal dispersion liquid according to the embodiment of the present disclosure is used for image recording according to an ink jet method, it is preferable that the metal dispersion liquid contains an organic solvent from the viewpoint of the jettability.

The organic solvent is not particularly limited, but a water-soluble organic solvent is preferable.

Further, the term “water-soluble” in the water-soluble organic solvent indicates a property in which 5 g or greater (preferably 10 g or greater) of the organic solvent is dissolved in 100 g of water at 25° C.

The water-soluble organic solvent is not particularly limited.

Examples of the water-soluble organic solvent include polyhydric alcohols such as glycerin, 1,2,6-hexanetriol, trimethylolpropane, ethylene glycol, propylene glycol, diethylene glycol, triethylene glycol, tetraethylene glycol, pentaethylene glycol, dipropylene glycol, 2-butene-1,4-diol, 2-ethyl-1,3-hexanediol, 2-methyl-2,4-pentanediol, 1,2-octanediol, 1,2-hexanediol, 1,2-pentanediol, and 4-methyl-1,2-pentanediol; alkyl alcohols having 1 to 4 carbon atoms such as ethanol, methanol, butanol, propanol, and isopropanol; glycol ethers such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-t-butyl ether, 1-methyl-1-methoxy butanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, tripropylene glycol monomethyl ether, dipropylene glycol mono-n-propyl ether, and dipropylene glycol mono-iso-propyl ether; and pyrrolidones such as 2-pyrrolidone and N-methyl-2-pyrrolidone.

The water-soluble organic solvent can be appropriately selected from, for example, the water-soluble organic solvents described in paragraphs [0176] to [0179] of JP2011-046872A and the water-soluble organic solvents described in paragraphs [0063] to [0074] of JP2013-018846A in addition to those described above.

Further, among the water-soluble organic solvents, polyhydric alcohols are useful as an anti-drying agent or a wetting agent.

Examples of the polyhydric alcohols serving as an anti-drying agent or a wetting agent include polyhydric alcohols described in paragraph [0117] of JP2011-042150A.

As the water-soluble organic solvent, an organic solvent (hereinafter, also referred to as a “specific organic solvent”) having a boiling point of 150° C. or higher and a solubility parameter (hereinafter, also referred to as an “SP” value) of 24 MPa^{1/2} or greater is preferable.

For example, in a case where the metal dispersion liquid according to the embodiment of the present disclosure is used for image recording according to an ink jet method, it is preferable that the boiling point of the water-soluble organic solvent contained in the ink is 150° C. or higher (in other words, the boiling point of the water-soluble organic solvent is higher than the boiling point of water) from the viewpoint that degradation of the jettability of the metal dispersion liquid due to volatilization of the solvent is further suppressed.

The boiling point of the water-soluble organic solvent is more preferably 170° C. or higher and still more preferably 180° C. or higher.

The upper limit of the boiling point of the water-soluble organic solvent is not particularly limited, but is preferably 300° C. or less.

The boiling point of the water-soluble organic solvent is a value measured using a boiling point measuring device (DosaTherm300, manufactured by Titan Technologies, Inc.). In the present disclosure, the boiling point indicates a boiling point measured under the atmospheric pressure.

Further, it is preferable that the SP value of the water-soluble organic solvent is 24 MPa^{1/2} or greater from the viewpoint that the aligning properties of the tabular metal particles in the metal dispersion liquid applied onto the base material are improved so that the specular glossiness of the film to be formed is further improved.

The SP value of the water-soluble organic solvent is more preferably 25 MPa^{1/2} or greater, still more preferably 26 MPa^{1/2} or greater, and particularly preferably 27 MPa^{1/2} or greater.

The upper limit of the SP value of the water-soluble organic solvent is not particularly limited, but is preferably 40 MPa^{1/2} or less.

The solubility parameter (SP value) of the water-soluble organic solvent is a value [unit: MPa^{1/2}] acquired using an Okitsu method. The Okitsu method is a known method of calculating the SP value in the related art and is described in Journal of the Adhesion Society of Japan, Vol. 29, No. 6 (1993), p. 249 to 259.

Hereinafter, specific examples of the specific organic solvent will be described. Further, the numerical values in parentheses indicate boiling points (unit: ° C.) and SP values (unit: MPa^{1/2}) in order of the description.

Specific examples thereof include ethylene glycol (197° C., 29.9 MPa^{1/2}), diethylene glycol (244° C., 24.8 MPa^{1/2}), propylene glycol (188° C., 27.6 MPa^{1/2}), 1,4-butanediol (230° C., 30.7 MPa^{1/2}), 1,2-pentanediol (206° C., 28.6 MPa^{1/2}), 1,5-pentanediol (206° C., 29.0 MPa^{1/2}), 1,6-hexanediol (250° C., 27.7 MPa^{1/2}), glycerin (290° C., 33.8 MPa^{1/2}), formamide (210° C., 39.3 MPa^{1/2}), dimethylformamide (153° C., 30.6 MPa^{1/2}), triethanolamine (208° C. (20 hPa), 32.3 MPa^{1/2}), polyethylene glycol (250° C., 26.1 MPa^{1/2}), 1,2-hexanediol (223° C., 24.1 MPa^{1/2}), and dipropylene glycol (230° C., 27.1 MPa^{1/2}).

Among these, at least one selected from the group consisting of propylene glycol, glycerin, and ethylene glycol is preferable as the specific organic solvent. These specific organic solvents are preferable from the viewpoint of further improving the jettability of the metal dispersion liquid in a case where the metal dispersion liquid according to the embodiment of the present disclosure is used for image recording according to an ink jet method.

In a where the metal dispersion liquid according to the embodiment of the present disclosure contains an organic solvent, the metal dispersion liquid may contain only one or two or more kinds of organic solvents.

In the case where the metal dispersion liquid according to the embodiment of the present disclosure contains an organic solvent, the content of the organic solvent in the metal dispersion liquid is not particularly limited.

The content of the organic solvent (preferably the specific organic solvent) in the metal dispersion liquid according to the embodiment of the present disclosure is preferably in a range of 5% by mass to 80% by mass, more preferably in a range of 5% by mass to 70% by mass, still more preferably in a range of 5% by mass to 50% by mass, and particularly preferably in a range of 10% by mass to 40% by mass with respect to the total amount of the metal dispersion liquid.

[Surfactant]

The metal dispersion liquid according to the embodiment of the present disclosure may contain a surfactant.

In a case where the metal dispersion liquid according to the embodiment of the present disclosure contains a surfactant, a fluorine-based surfactant is preferable as the surfactant.

In a case where the metal dispersion liquid according to the embodiment of the present disclosure contains a fluorine-based surfactant, since the surface tension of the metal dispersion liquid is decreased, the aligning properties of the tabular metal particles in the metal dispersion liquid which has been applied onto the base material can be improved. As the result, a film with excellent specular glossiness can be formed.

The fluorine-based surfactant is not particularly limited and can be selected from known fluorine-based surfactants.

Examples of the fluorine-based surfactant include fluorine-based surfactants described in “Surfactant Handbook” (edited by Ichiro Nishi, Ichiro Imai, and Masatachi Kasai, Sangyo Tosho Publishing Co., Ltd., 1960).

As the fluorine-based surfactant, a fluorine-based surfactant containing a perfluoro group in a molecule and having a refractive index of 1.30 to 1.42 (preferably in a range of 1.32 to 1.40) is preferable.

According to the fluorine-based surfactant having a refractive index of 1.30 to 1.42, the specular glossiness of the film to be formed can be further improved.

The refractive index of the fluorine-based surfactant is a value measured using a Kalnew precision refractometer (KPR-3000, manufactured by Shimadzu Corporation). In a case where the fluorine-based surfactant is a liquid, the refractive index is measured by storing the fluorine-based surfactant in a cell. In a case where the fluorine-based surfactant is a solid, the refractive index is measured using a V block method of placing the solid sample in a V block prism attached to a Kalnew precision refractometer (KPR-3000, manufactured by Shimadzu Corporation).

In a case where the fluorine-based surfactant contains a perfluoro group in a molecule, the refractive index of the fluorine-based surfactant is easily adjusted to be in the above-described range, and the surface tension of the metal dispersion liquid can be adjusted with a relatively small amount of the fluorine-based surfactant.

Examples of the fluorine-based surfactant containing a perfluoro group in a molecule and having a refractive index of 1.30 to 1.42 include an anionic surfactant such as perfluoroalkyl carbonate, perfluoroalkyl sulfonate, or perfluoroalkyl phosphoric acid ester; an amphoteric surfactant such as perfluoroalkyl betaine; a cationic surfactant such as perfluoroalkyltrimethylammonium salt; and a nonionic surfactant such as perfluoroalkylamine oxide, a perfluoroalkylethylene oxide adduct, an oligomer containing a perfluoroalkyl group and a hydrophilic group, an oligomer containing a perfluoroalkyl group and a lipophilic group, an oligomer containing a perfluoroalkyl group, a hydrophilic group, and a lipophilic group, or urethane containing a perfluoroalkyl group and a lipophilic group. Further, suitable examples thereof include fluorine-based surfactants described in JP1987-170950A (JP-S62-170950A), JP1987-226143A (JP-S62-226143A), and JP1985-168144A (JP-S60-168144A).

As the fluorine-based surfactant, a commercially available product may be used.

Examples of the commercially available product of the fluorine-based surfactant include SURFLON (registered trademark) Series (S-243, S-242, and the like, manufactured by AGC SEIMI CHEMICAL CO., LTD.), MEGAFACE (registered trademark) Series (F-444, F-410, and the like, manufactured by DIC Corporation), NOVEC (registered trademark) Series (for example, 27002, manufactured by 3M Japan Ltd.), and ZONYL Series (for example, FSE, manufactured by E. I. du Pont de Nemours and Company).

In a case where the metal dispersion liquid according to the embodiment of the present disclosure contains a surfactant, the metal dispersion liquid may contain only one or two or more kinds of surfactants.

In the case where the metal dispersion liquid according to the embodiment of the present disclosure contains a surfactant, the content of the surfactant in the metal dispersion liquid is not particularly limited.

The content of the surfactant (preferably the fluorine-based surfactant) in the metal dispersion liquid according to the embodiment of the present disclosure is preferably in a range of 0.01% by mass to 5.0% by mass, more preferably in a range of 0.03% by mass to 1.0% by mass, and still more preferably in a range of 0.03% by mass to 0.5% by mass with respect to the total amount of the metal dispersion liquid.

In a case where the content of the surfactant in the metal dispersion liquid according to the embodiment of the present disclosure is in the above-described range, the surface tension of the metal dispersion liquid is likely to be adjusted such that the jettability of the metal dispersion liquid is further improved in the case where the metal dispersion liquid is used as an ink for ink jet recording, that is, the metal dispersion liquid is used for image recording according to an ink jet method.

[Other Components]

The metal dispersion liquid composition according to the embodiment of the present disclosure may contain components other than the above-described component (so-called other components) as necessary.

Examples of other components include a preservative and an antifoaming agent.

The preservative can refer to the description in paragraphs [0073] to [0090] of JP2014-184688A.

The antifoaming agent can refer to the description in paragraphs [0091] and [0092] of JP2014-184688A.

Further, examples of other components include a solid wetting agent (for example, urea), an antifading agent, an emulsification stabilizer, a penetration enhancer, an ultraviolet absorbing agent, a fungicide, a pH adjuster, a rust inhibitor, and a chelating agent.

Further, as other components, polymer particles are also exemplified.

Examples of the polymer particles include self-dispersing polymer particles described in paragraphs [0090] to [0121] of JP2010-064480A, paragraphs [0130] to [0167] of JP2011-068085A, and paragraphs [0180] to [0234] of JP2011-062998A.

The metal dispersion liquid according to the embodiment of the present disclosure may contain a colorant (a pigment, a dye, or the like).

From the viewpoints of light fastness of a film (for example, an image) and the weather fastness of a film (for example, an image), a pigment is preferable as the colorant.

The pigment is not particularly limited and can be appropriately selected depending on the purpose thereof.

Examples of the pigment include known organic pigments and inorganic pigments.

Examples of the organic pigments and inorganic pigments include a yellow pigment, a red pigment, a magenta pigment, a blue pigment, a cyan pigment, a green pigment, an orange pigment, a purple pigment, a brown pigment, a black pigment, and a white pigment. Further, examples of the pigment include surface-treated pigments (for example, a pigment whose surface is treated with a dispersant such as a resin or a pigment derivative and a self-dispersing pigment having particles, each of which contains a hydrophilic group). In addition, as the pigment, a commercially available pigment dispersion may be used.

In a case where a pigment is used as the colorant, a pigment dispersant may be used as necessary.

The coloring material such as a pigment and the pigment dispersant can appropriately refer to the description in paragraphs [0180] to [0200] of JP2014-040529A.

Here, in a case where a metallic tone film (for example, an image) in which a tint is suppressed is formed (recorded or the like), the content of the colorant in the metal dispersion liquid according to the embodiment of the present disclosure is preferably 1% by mass or less, more preferably less than 1% by mass, still more preferably 0.1% by mass or less, and most preferably 0% by mass (that is, the metal dispersion liquid according to the embodiment of the present disclosure does not contain a colorant) with respect to the total amount of the metal dispersion liquid.

Further, the metal dispersion liquid according to the embodiment of the present disclosure may be used as a photocurable ink containing at least one polymerizable compound. In this case, it is preferable that the metal dispersion liquid further contains a polymerization initiator.

Examples of the polymerizable compound include the polymerizable compounds (such as a bi- or higher functional (meth)acrylamide compound) described in paragraphs [0128] to [0144] of JP2011-184628A, paragraphs [0019] to [0034] of JP2011-178896A, and paragraphs [0065] to [0086] of JP2015-025076A.

Examples of the polymerization initiator include known polymerization initiators described in paragraphs [0186] to [0190] of JP2011-184628A, paragraphs [0126] to [0130] of JP2011-178896A, and paragraphs [0041] to [0064] of JP2015-025076A.

<Preferable Physical Properties of Metal Dispersion Liquid>

The physical properties of the metal dispersion liquid according to the embodiment of the present disclosure are not particularly limited, but the following physical properties are preferable.

The pH of the metal dispersion liquid according to the embodiment of the present disclosure at 25° C. (±1° C.) is more preferably in 7.5 or greater, more preferably in a range of 7.5 to 12, and still more preferably in a range of 7.5 to 10.

The surface tension of the metal dispersion liquid according to the embodiment of the present disclosure at 25° C. (±1° C.) is preferably 60 mN/m or less, more preferably in a range of 20 mN/m to 50 mN/m, and still more preferably in a range of 25 mN/m to 45 mN/m.

From the viewpoints of improving the wettability and suppressing occurrence of curling in the base material, it is advantageous that the surface tension of the metal dispersion liquid is 60 mN/m or less.

The surface tension of the metal dispersion liquid according to the embodiment of the present disclosure is measured using an Automatic Surface Tensiometer CBVP-Z (manufactured by Kyowa Interface Science, Inc.) according to a plate method.

<Applications of Metal Dispersion Liquid>

The metal dispersion liquid according to the embodiment of the present disclosure can be suitably used as a liquid for forming a film (for example, an image) on a base material (for example, a recording medium). Examples of such a liquid include a coating solution (for example, a coating liquid) for forming a coated film on a base material and an ink [for example, an ink used for a ballpoint pen (that is, an ink for a ballpoint pen) and an ink used for ink jet recording (that is, an ink for ink jet recording)] for forming an image on a base material as a recording medium.

Since the metal dispersion liquid according to the embodiment of the present disclosure has the thixotropic properties, liquid dripping after application is unlikely to occur in a case where the metal dispersion liquid is used as a coating solution.

Further, since the metal dispersion liquid according to the embodiment of the present disclosure has the thixotropic properties, excellent jettability is exhibited in a case where the metal dispersion liquid is used as an ink for ink jet recording, and thus a sharp image can be recorded. The metal dispersion liquid according to the embodiment of the present disclosure exhibits excellent jettability because the metal dispersion liquid has a moderate viscosity which is not extremely high at the time of jetting. Further, the metal dispersion liquid is rapidly thickened after being applied onto the base material. Therefore, spread of liquid droplets and occurrence of landing interference or the like are suppressed, and thus a sharper image can be recorded.

Since the metal dispersion liquid according to the embodiment of the present disclosure can be used for recording an image with a sharp image quality and also be used for recording an image with a suppressed tint, it is preferable that the metal dispersion liquid is used for recording a decorative image, particularly, a decorative image according to an ink jet method.

The “recording of a decorative image” indicates general recording of an image for the purpose of adding decoration to an object. The recording of a decorative image is different from the recording carried out for the purpose other than the above-described purpose (for example, recording for forming a conductive line).

In a case where the metal dispersion liquid according to the embodiment of the present disclosure is used for recording a decorative image, decoration of a sharp image with specular glossiness and a suppressed tint can be added to an object.

From the viewpoint of effectively obtaining the effect of specular glossiness, it is preferable that the metal dispersion liquid according to the embodiment of the present disclosure is used for recording an image having a minimum width of 1 mm or greater.

The minimum width of the image to be recorded with the metal dispersion liquid according to the embodiment of the present disclosure is more preferably 2 mm or greater and still more preferably 3 mm or greater.

The upper limit of the minimum width of the image to be recorded with the metal dispersion liquid according to the embodiment of the present disclosure is not particularly limited. For example, the upper limit thereof is 300 mm or less and preferably 200 mm or less.

<Method of Producing Metal Dispersion Liquid>

A method of producing the metal dispersion liquid according to the embodiment of the present disclosure is not particularly limited, and a method of mixing respective components described above is exemplified.

According to the method of producing the metal dispersion liquid according to the embodiment of the present disclosure, it is preferable that the tabular metal particles are blended as the dispersion liquid containing the tabular metal particle at the time of blending the tabular metal particles.

In other words, as a preferable aspect of the method of producing the metal dispersion liquid according to the embodiment of the present disclosure, an aspect of mixing the dispersion liquid containing the tabular metal particles, the specific water-soluble resin, the specific polycarboxylic acid or the like, water, and other components such as an organic solvent and a surfactant as necessary is exemplified.

The specific water-soluble resin and the specific polyvalent carboxylic acid or the like may be contained in the dispersion liquid containing the tabular metal particles by being used at the time of preparation of the dispersion liquid containing the tabular metal particles.

In a case where the salt of the specific polycarboxylic acid is used, it is considered that at least one of the specific polycarboxylic acid from which the salt has been dissociated or the salt of the specific polycarboxylic acid is present in the metal dispersion liquid.

<Ink Set>

The metal dispersion liquid according to the embodiment of the present disclosure can be suitably used as an ink constituting an ink set.

The ink set in a case where the metal dispersion liquid according to the embodiment of the present disclosure is used as an ink is not particularly limited, but an ink set according to the present embodiment described below is preferable.

The ink set according to the present disclosure includes a first ink which is the above-described metal dispersion liquid according to the embodiment of the present disclosure and a second ink which contains a colorant and is different from the first ink.

The ink set according to the embodiment of the present disclosure is an ink set which is capable of recording an image formed by combining an image having specular glossiness (a so-called specular image) and a colored image that does not have specular glossiness.

According to an aspect of a preferable use for the ink set according to the present embodiment, an image (that is, a specular image) formed of the first ink and a colored image formed of the second ink are formed on the base material in parallel with each other or in an overlapping manner.

In a case where the specular image formed of the first ink and the colored image formed of the second ink are formed in an overlapping manner, any of the specular image formed of the first ink or the colored image formed of the second ink may be used as an underlayer (that is, a layer on a side close to the base material).

In a case where the specular image formed of the first ink is used as an underlayer (that is, a layer on a side close to the base material) and the colored image formed of the second ink is used as an upper layer (that is, a layer on a side far from the base material), a colored image having specular glossiness is obtained in a portion where the specular image formed of the first ink and the colored image formed of the second ink overlap with each other.

In a case where the colored image formed of the second ink is used as an underlayer (that is, a layer on a side close to the base material) and the specular image formed of the first ink is used as an upper layer (that is, a layer on a side far from the base material), the colored image formed of the second ink can be hidden by the image (for example, a silver image) formed of the first ink in a portion where the specular image formed of the first ink and the colored image formed of the second ink overlap with each other.

Since the details of the first ink are the same as described in the section of the metal dispersion liquid, the description thereof will not be provided here.

The second ink is not particularly limited as long as the ink contains a colorant and can be appropriately selected from known inks.

It is preferable that the second ink contains an achromatic ink containing a black or white colorant or at least one selected from chromatic inks containing R (so-called red), G (so-called green), B (so-called blue), Y (so-called yellow), M (so-called magenta), and C (so-called cyan) colorants.

The second ink may be an aqueous ink containing water as a main vehicle or a solvent-based ink containing a solvent as a main vehicle.

Further, the second ink may be a photocurable ink containing a polymerizable compound and a photopolymerization initiator.

Examples of the colorant include colorants such as pigments and dyes.

Among these, from the viewpoints of light fastness of an image and the weather fastness of an image, a pigment is preferable as the colorant.

The pigment is not particularly limited and can be appropriately selected depending on the purpose thereof.

Examples of the pigment include known organic pigments and inorganic pigments.

Examples of the organic pigments and inorganic pigments include a yellow pigment, a red pigment, a magenta pigment, a blue pigment, a cyan pigment, a green pigment, an orange pigment, a purple pigment, a brown pigment, a black pigment, and a white pigment.

Further, examples of the pigment include surface-treated pigments (for example, a pigment whose surface is treated with a dispersant such as a resin or a pigment derivative and a self-dispersing pigment having particles, each of which contains a hydrophilic group. In addition, as the pigment, a commercially available pigment dispersion may be used.

In a case where a pigment is used as the colorant, a pigment dispersant may be used as necessary.

The coloring material such as a pigment and the pigment dispersant can appropriately refer to the description in paragraphs [0180] to [0200] of JP2014-040529A.

The second ink may contain only one or two or more kinds of colorants.

From the viewpoint of the density of the image, the content of the colorant (preferably a pigment) in the second ink is preferably 1% by mass or greater, more preferably in a range of 1% by mass to 20% by mass, and still more preferably in a range of 2% by mass to 10% by mass with respect to the total amount of the second ink.

In the ink set according to the present embodiment, it is preferable that the content of the colorant in the first ink is less than 1% by mass (more preferably 0.1% by mass or less) with respect to the total amount of the first ink and the content of the colorant in the second ink is 1% by mass or greater (more preferably in a range of 1% by mass to 20% by mass and still more preferably in a range of 2% by mass to 10% by mass) with respect to the total amount of the second ink.

[Image Recording Method]

The metal dispersion liquid according to the embodiment of the present disclosure can be used for recording an image.

The image recording method that uses the metal dispersion liquid according to the embodiment of the present disclosure is not particularly limited, but the following image recording method (hereinafter, also referred to as an “image recording method according to a first embodiment”) according to the present embodiment is preferable.

The image recording method according to the first embodiment of the present disclosure includes a step (hereinafter, also referred to as an “application step”) of applying the metal dispersion liquid according to the embodiment of the present disclosure onto the base material according to an ink jet method.

In the image recording method according to the first embodiment of the present disclosure, the metal dispersion liquid according to the embodiment of the present disclosure is used as an ink for ink jet recording. Since the metal dispersion liquid according to the embodiment of the present disclosure has the thixotropic properties and exhibits a moderate viscosity which is not extremely high at the time of moving, the jettability of the metal dispersion liquid at the time of being applied onto the base material according to an ink jet method becomes excellent in a case of using the image recording method according to the first embodiment of the present disclosure. Further, since the metal dispersion liquid according to the embodiment of the present disclosure has the thixotropic properties and is rapidly thickened at the time of standing still, spread of liquid droplets, landing interference, and the like are unlikely to occur on the base material in a case of using the image recording method according to the first embodiment of the present disclosure. Therefore, a sharp image can be recorded. Further, according to the image recording method according to the first embodiment of the present disclosure, an image having specular glossiness and a suppressed tint can be recorded.

As the base material, a paper base material, a resin base material, or the like can be used without particular limitation.

Examples of the paper base material include plain paper, glossy paper, and coated paper.

The glossy paper is a paper base material comprising base paper and polymer fine particles or porous fine particles disposed on the base paper.

The glossy paper are not particularly limited. Examples of the commercially available products of the glossy paper include “KASSAI (registered trademark)” (manufactured by Fujifilm corporation), photo paper and photo glossy paper (manufactured by Seiko Epson Corporation), and glossy paper (manufactured by Konica Minolta, Inc.).

Coated paper is a paper base material comprising base paper and a coating layer disposed on the base paper.

The coated paper is not particularly limited. Examples of the commercially available products of the coated paper include “OK TOP COAT (registered trademark)+” (manufactured by Oji Paper Co., Ltd.), and “AURORA COAT” (manufactured by Nippon Paper Industries Co., Ltd.).

From the viewpoint that an image with excellent specular glossiness can be recorded, as the paper base material, glossy paper or coated paper is preferable, and glossy paper is more preferable.

Examples of the resin base material include a resin film.

Examples of the resin film include polyvinyl chloride (PVC), cellulose diacetate, cellulose triacetate, cellulose propionate, cellulose butyrate, cellulose acetate butyrate, cellulose nitrate, polyethylene terephthalate (PET), polyethylene naphthalate, polyethylene, polystyrene, polypropylene, polycarbonate, polyvinyl acetate, and an acrylic resin.

Among these, from the viewpoint that an image with excellent specular glossiness can be recorded, as the resin film, a PVC film or a PET film is preferable, and a PET film is more preferable.

The above-described base material may include an ink image-receiving layer provided for the purpose of improving the fixing property of the ink and the image quality as necessary.

Further, the base material may be a base material on which an image has already been recorded. In other words, the image recording method according to the first embodiment may be a method of recording an image using the metal dispersion liquid according to the embodiment of the present disclosure on the image (a so-called recorded image) of the base material, on which an image has already been recorded.

By recording an image using the metal dispersion liquid according to the embodiment of the present disclosure on the image which has already been recorded on the base material, decoration with specular glossiness can be added to the image which has already been recorded on the base material. Further, the image which has already been recorded on the base material can be hidden by an image (for example, a silver image) to be recorded using the metal dispersion liquid according to the embodiment of the present disclosure.

The system of the ink jet method is not particularly limited and can be appropriately selected from known systems.

Examples of the system of the ink jet method include an electric charge control system of jetting an ink using electrostatic attraction; a drop-on-demand system (pressure pulse system) of using the vibration pressure of a piezoelectric element; an acoustic ink jet system of converting an electric signal to an acoustic beam, irradiating an ink with the acoustic beam, and jetting the ink using a radiation pressure; and a thermal ink jet (Bubble Jet (registered trademark)) system of forming bubbles by heating an ink to use the generated pressure.

The ink jet head system may be an on-demand system or a continuous system.

The system of jetting the ink from the ink jet head is not particularly limited.

Examples of the ink jetting system include an electro-mechanical conversion system (a single cavity type, a double cavity type, a vendor type, a piston type, a share mode type, a shared wall type, or the like); an electricity-heat conversion system (a thermal ink jet type, a Bubble Jet (registered trademark) type, or the like); an electrostatic attraction system (an electric field control type, a silt jet type, or the like); and a discharge system (a spark jet type).

Examples of the recording system in the ink jet method include a shuttle system of performing recording while scanning the head in a width direction of the base material using a single serial head; and a line system (single pass system) of using a line head in which recording elements are arranged over the entire area on one side of the base material.

From the viewpoint that an image with high resolution can be recorded, the nozzle diameter of the jet head is not particularly limited, but is preferably less than 25 μm, more preferably 5 μm or greater and less than 25 μm, still more preferably 10 μm or greater and less than 25 μm, and particularly preferably 15 μm or greater and less than 25 μm.

The image recording method according to the first embodiment of the present disclosure may include a step of drying the metal dispersion liquid applied onto the base material.

The drying may be natural drying at room temperature or heat drying.

In a case where a resin base material is used as the base material, heat drying is preferable.

The means for heat drying is not particularly limited, and examples thereof include a heat drum, warm air, an infrared lamp, and a heat oven.

The temperature for heat drying is preferably 50° C. or higher, more preferably in a range of 60° C. to 150° C., and still more preferably in a range of 70° C. to 100° C.

The time for heat drying can be appropriately set in consideration of the composition of the metal dispersion liquid and the amount of the metal dispersion liquid to be jetted and is preferably in a range of 1 minute to 180 minutes, more preferably in a range of 5 minutes to 120 minutes, and still more preferably in a range of 5 minutes to 60 minutes.

Examples of the image recording method that uses the metal dispersion liquid according to the embodiment of the present disclosure include the following image recording method according to a second embodiment of the present disclosure in addition to the image recording method according to the first embodiment of the present disclosure described above. In the image recording method according to the second embodiment of the present disclosure, the ink set according to the present embodiment described above is used.

The image recording method according to the second embodiment of the present disclosure includes a step of applying the first ink (hereinafter, also referred to as a “first ink application step”) which is the metal dispersion liquid according to the embodiment of the present disclosure to the base material using an ink jet method and a step of applying the second ink (hereinafter, also referred to as a “second ink application step”) which contains a colorant and is different from the first ink to the base material.

Any of the first ink application step or the second ink application step may be performed first.

The image recording method according to the second embodiment of the present disclosure may include a step of drying the ink (that is, at least one of the first ink or the second ink) applied to the base material at the time of at least one of between the first ink application step and the second ink application step or after the step performed later between the first ink application step and the second ink application step. Since the details of the step of drying the ink (that is, at least one of the first ink or the second ink) are the same as the step of drying the metal dispersion liquid in the image recording method according to the first embodiment of the present disclosure, the description thereof will not be provided here.

A preferable aspect of the image recording method according to the second embodiment of the present disclosure is an aspect in which the second ink application step is performed after the first ink application step, specifically, an aspect in which the method includes a step of applying the first ink (that is, the “first ink application step”) to the base material using an ink jet method and a step of applying the second ink (that is, the “second ink application step”) on the first ink of the base material to which the first ink has been applied.

According to this aspect, a colored image having specular glossiness can be formed in a portion where a specular image formed of the first ink and a colored ink formed of the second ink overlap with each other.

Another preferable aspect of the image recording method according to the second embodiment of the present disclosure is an aspect in which the second ink application step is performed after the first ink application step, specifically, an aspect in which the method includes a step of applying the second ink (that is, the “second ink application step”) to the base material using an ink jet method and a step of applying the first ink (that is, the “first ink application step”) on the second ink of the base material to which the second ink has been applied according to an ink jet method.

According to this aspect, a colored image formed of the second ink can be hidden by an image formed of the first ink (for example, a silver image).

A preferable aspect of the first ink application step is the same as the application step in the above-described image recording method according to the first embodiment of the present disclosure.

The method of applying the second ink in the second ink application step is not particularly limited, and a method of applying an ink to a base material in a known image recording method can be employed.

The second ink application step may be performed under the same conditions as those for the first ink application step or performed under the conditions different from those for the first ink application step.

[Recorded Object]

The metal dispersion liquid according to the embodiment of the present disclosure can be used for preparation of a recorded object.

Since the metal dispersion liquid according to the embodiment of the present disclosure has the thixotropic properties, a recorded object comprising a sharp image can be prepared. According to the metal dispersion liquid according to the embodiment of the present disclosure, a recorded object comprising an image having specular glossiness and a suppressed tint can be prepared.

As the recorded object prepared using the metal dispersion liquid according to the embodiment of the present disclosure, the following recorded object according to the present embodiment of the present disclosure is exemplified.

The recorded object according to the present embodiment of the present disclosure comprises a base material, and an image which is disposed on the base material and contains tabular metal particles and a water-soluble resin (that is, the specific water-soluble resin) containing at least one functional group selected from the group consisting of a carboxy group, an amino group, and a thiol group, in which at least one of the base material or the image contains a polycarboxylic acid having a partial structure which connects carbon atoms in two carboxy groups to each other and has four or more linearly bonded atoms, or a salt thereof (that is, the specific polycarboxylic acid or the like).

The aspect of the base material in the recorded object according to the embodiment of the present disclosure is the same as the preferable aspect of the base material used in the image recording method according to the present embodiment of the present disclosure.

The preferable aspect of the tabular metal particles in the recorded object according to the present embodiment of the present disclosure is the same as the preferable aspect of the tabular metal particles in the metal dispersion liquid according to the embodiment of the present disclosure.

The preferable aspect of the specific water-soluble resin in the recorded object according to the present embodiment of the present disclosure is the same as the preferable aspect of the specific water-soluble resin in the metal dispersion liquid according to the embodiment of the present disclosure.

The preferable aspect of the specific polycarboxylic acid or the like in the recorded object according to the present embodiment of the present disclosure is the same as the preferable aspect of the specific polycarboxylic acid or the like in the metal dispersion liquid according to the embodiment of the present disclosure.

The preferable aspect (for example, the minimum width of the image) of the image in the recorded object according to the present embodiment of the present disclosure is the same as the preferable aspect of the image described in the section of the “applications of metal dispersion liquid”.

The image in the recorded object according to the present embodiment of the present disclosure may contain components (preferably components other than water and an organic solvent) exemplified as the components of the metal dispersion liquid according to the embodiment of the present disclosure.

The recorded object according to the present embodiment of the present disclosure contains the specific polycarboxylic acid or the like in at least one of the base material or the image.

The expression of “containing the specific polycarboxylic acid or the like in the base material” does not mean that the specific polycarboxylic acid or the like constitutes a part of the base material, but means at least one of being present in the base material separately from the constituent elements of the base material or being present on the base material.

The recorded material according to the present embodiment of the present disclosure may comprise an image containing a colorant (that is, a colored image) on at least one of the image containing the tabular metal particles or a space between the base material and the image containing the tabular metal particles.

In a case where the recorded material according to the present embodiment of the present disclosure comprises the colored image on the image containing the tabular metal particles, a colored image having specular glossiness is provided in a portion where the image containing the tabular metal particles and the colored image overlap with each other.

Further, in a case where the recorded material according to the present embodiment of the present disclosure comprises the colored image between the base material and the image containing the tabular metal particles, the colored image is hidden by the image containing the tabular metal particles (for example, a silver image) in a portion where the image containing the tabular metal particles and the colored image overlap with each other.

The recorded image comprising an image that contains tabular metal particles or the like and a colored image can be prepared using the metal dispersion liquid according to the embodiment of the present disclosure and a known ink containing a colorant.

### EXAMPLES

Hereinafter, the present invention will be described in more detail based on the following examples. However, the present invention is not limited to the following examples unless the gist thereof is overstepped.

### Example 1

1. Preparation of Metal Dispersion Liquid

—Preparation of Metal Particle-Forming Liquid—

A reaction container made of high Cr—Ni-Mo stainless steel (NTKR-4, manufactured by Nippon Metal Industry Co., Ltd.) was prepared. This reaction container comprises an agitator formed by attaching four propellers made of NTKR-4 and four paddles made of NTKR-4 to a shaft made of stainless steel (SUS316L).

While 13 liters (L) of ion exchange water was added to the reaction container and stirred using the agitator, 10 g/L of a 1.0 L trisodium citrate (anhydride) aqueous solution was added thereto. The temperature of the obtained liquid was maintained to 35° C.

8.0 g/L of a 0.68 L polystyrene sulfonic acid aqueous solution was added to the liquid whose temperature was maintained to 35° C., and 0.041 L of a sodium borohydride aqueous solution in which the concentration of the sodium borohydride was adjusted to 23 g/L was further added thereto. The concentration of the sodium borohydride aqueous solution was adjusted using 0.04 N (mol/L) of a sodium hydroxide (NaOH) aqueous solution.

0.10 g/L of a 15 L silver nitrate aqueous solution was further added to the liquid, to which the sodium borohydride aqueous solution had been added, at a rate of 5.0 L/min.

10 g/L of a 2.0 L trisodium citrate (anhydride) aqueous solution and 11 L of ion exchange water were further added to the obtained liquid, and 80 g/L of a 0.68 L potassium hydroquinone sulfonate aqueous solution was further added thereto.

Next, the rate of the stirring was increased to 800 rpm (revolutions per minute; the same applies hereinafter), 0.10 g/L of a 8.1 L silver nitrate aqueous solution was added to the solution at a rate of 0.95 L/min, and the temperature of the obtained liquid was decreased to 30° C.

Next, 44 g/L of an 8.0 L methyl hydroquinone aqueous solution was added to the resulting liquid cooled to 30° C., and the total amount of the gelatin aqueous solution at 40° C. described below was added thereto.

Thereafter, the rate of the stirring was increased to 1200 rpm, the total amount of the silver sulfite white precipitate mixed solution described below was added thereto.

The pH of the liquid to which the silver sulfite white precipitate mixed solution had been added was gradually changed. At the time at which the change in pH of the liquid was stopped, 1 N (mol/L) of a 5.0 L NaOH aqueous solution was added to the resulting liquid at a rate of 0.33 L/min. The pH of the obtained liquid was adjusted to 7.0±1.0 using NaOH and citric acid (anhydride). Next, 2.0 g/L of a 0.18 L sodium 1-(m-sulfophenyl)-5-mercaptotetrazole aqueous solution was added to the liquid after the adjustment of the pH thereof, and 70 g/L of a 0.078 L 1,2-benzisothiazolin-3-one aqueous solution which was dissolved by being adjusted to be alkaline was added thereto. In the manner described above, a metal particle-forming liquid was obtained.

The metal particle-forming liquid was liquid-separated and accommodated in 20 L of a Union Container II type container (a low-density polyethylene container, manufactured by AS ONE Corporation) and stored at 30° C.

Further, the physical characteristics of the metal particle-forming liquid were as follows.

(Physical Characteristics of Metal Particle-Forming Liquid)
pH: 9.4 (a value measured by adjusting the liquid temperature of the metal particle-forming liquid to 25° C. using KRSE (manufactured by AS ONE Corporation))
Electrical conductivity: 8.1 mS/cm (a value measured using CM-25R (manufactured by DKK-TOA Corporation))

<<Preparation of Gelatin Aqueous Solution>>

A dissolution tank made of SUS316L comprising an agitator made of SUS316L was prepared.

16.7 L of ion exchange water was poured into this dissolution tank, and 1.4 kg of alkali-treated bovine bone gelatin (weight-average molecular weight: 200000, value measured by GPC) which had been subjected to a deionization treatment was added to the dissolution tank while the ion exchange water was stirred using the agitator at a low speed.

0.91 kg of alkali-treated bovine bone gelatin (weight-average molecular weight: 21000, value measured by GPC) which had been subjected to a deionization treatment, a proteolytic enzyme treatment, and an oxidation treatment with hydrogen peroxide was further added to the obtained liquid.

Thereafter, the temperature of the liquid was increased to 40° C., and the gelatin was allowed to be completely dissolved therein by simultaneously performing swelling and dissolving of the gelatin.

In this manner, a gelatin aqueous solution was prepared.

<<Preparation of Silver Sulfite White Precipitate Mixed Solution>>

A dissolution tank made of SUS316L comprising an agitator made of SUS316L was prepared.

8.2 L of ion exchange water was poured into this dissolution tank, and 100 g/L of an 8.2 L silver nitrate aqueous solution was added thereto.

While the obtained liquid was stirred using the agitator at a high speed, 140 g/L of a 2.7 L sodium sulfite aqueous solution was added thereto in a short time, thereby preparing a mixed solution containing a white precipitate of silver sulfite (that is, a silver sulfite white precipitate mixed solution).

This silver sulfite white precipitate mixed solution was prepared immediately before use.

—Preparation of Metal Particle Dispersion Liquid (Desalting Treatment and Re-Dispersing Treatment)—

The metal particle-forming liquid was subjected to a desalting treatment and a re-dispersing treatment, thereby obtaining a metal particle dispersion liquid.

The detailed operation is as follows.

800 g of the metal particle-forming liquid prepared in the above-described manner was collected in a centrifuge tube, a centrifugation operation was performed thereon using a centrifuge (himacCR22GIII, angle rotor: R9A, manufactured by Hitachi Koki Co., Ltd.) under conditions of 35° C. at 9000 rpm for 60 minutes, and 784 g of the supernatant liquid was disposed of. 0.2 mmol/L of a NaOH aqueous solution was added to the remaining solid (in other words, a solid containing metal particles and gelatin) such that the total amount thereof was set to 40 g, and the solution was stirred by hand using a stirring rod, thereby obtaining a crude dispersion liquid X.

By performing the same operation as described above, 120 crude dispersion liquids X were prepared. All of these prepared crude dispersion liquids X (in other words, 4800 g in total) were added to a tank made of SUS316L and mixed. Next, 10 mL of a 10 g/L solution (as the solvent, a mixed solution of methanol and ion exchange water at a volume ratio of 1:1 was used) of Pluronic 31R1 (nonionic surfactant, manufactured by BASF SE) was further added thereto.

Next, a batch type dispersing treatment was performed on the mixture of the crude dispersion liquids X in the tank at 9000 rpm for 120 minutes using an automixer 20 type (manufactured by PRIMIX Corporation) (a homomixer MARKII as a stirring unit). The liquid temperature during the dispersing treatment was maintained at 50° C.

After the dispersing treatment, the liquid temperature of the solution was decreased to 25° C., and single pass filtration was performed using a Profile II filter (MCY1001Y030H13, manufactured by Pall Corporation).

In the above-described manner, a metal dispersion liquid (a so-called silver dispersion liquid) was prepared.

The metal dispersion liquid was accommodated in 20 L of a Union Container II type container (a low-density polyethylene container, manufactured by AS ONE Corporation) and stored at 30° C.

The content of the metal particles in the metal dispersion liquid was 15% by mass with respect to the total amount of the metal dispersion liquid. Further, the content of gelatin (specific water-soluble resin) in the metal dispersion liquid was 0.75% by mass with respect to the total amount of the metal dispersion liquid.

Further, the physical characteristics of the metal dispersion liquid were as follows.

(Physical Characteristics of Metal Dispersion Liquid)
pH: 7.0 (a value measured by adjusting the liquid temperature of the metal particle-forming liquid to 25° C. using KRSE (manufactured by AS ONE Corporation))
Electrical conductivity: 0.08 mS/cm (a value measured using CM-25R (manufactured by DKK-TOA Corporation))

(Shape of Metal Particles)

After the metal dispersion liquid was diluted, the liquid was added dropwise onto a grid mesh for an optical microscope and dried, thereby preparing a sample for observation. The shape of the metal particles contained in the metal dispersion liquid was confirmed by observing the prepared sample for observation using a transmission electron microscope (TEM). As the result, the shape was tabular.

(Average Equivalent Circle Diameter of Metal Particles)

TEM images of the sample for observation obtained by performing observation using a transmission electron microscope (TEM) were taken in image treatment software ImageJ (provided by National Institutes of Health (NIH)) to carry out an image treatment.

More specifically, image analysis was performed on 500 pieces of tabular metal particles optionally extracted from the TEM images with several visual fields, and the diameters of equivalent circles having the same area were calculated. The average equivalent circle diameter of the tabular metal particles was acquired by simply averaging (that is, the number average) the diameters of the equivalent circles having the same area of the obtained 500 pieces of tabular metal particles. As the result, the value was 120 nm.

(Average Thickness of Metal Particles)

The metal dispersion liquid was added dropwise onto a silicon substrate and dried to obtain a sample for observing the average thickness. Using the prepared sample for observing the average thickness, the thicknesses of 500 pieces of tabular metal particles contained in the metal dispersion liquid were respectively measured according to a focused ion beam-transmission electron microscopy (FIB-TEM) method. The average thickness of the tabular metal particles was acquired by simply averaging (number average) the thicknesses of 500 pieces of the tabular metal particles. As the result, the value was 6 nm.

(Average Aspect Ratio of Metal Particles)

The average aspect ratio of the metal particles was acquired by dividing the average equivalent circle diameter of the metal particles by the average thickness of the metal particles. As the result, the value was 20.

2. Preparation of Ink for Ink Jet Recording

An ink (that is, an ink for ink jet recording) of Example 1 with the following composition, which was suitable for image recording according to the ink jet method, was prepared using the metal dispersion liquid prepared in the above-described manner. The prepared ink for ink jet recording is also an aspect of the metal dispersion liquid.
—Composition of Ink—
Metal particles listed in Table 1 2% by mass
Gelatin the amount listed in Table 1

(a specific water-soluble resin, a water-soluble resin containing a carboxy group, an amino group, and a thiol group)
Propylene glycol 30% by mass

(a specific organic solvent, boiling point: 188° C., SP value: 27.6 (MPa)^{1/2})
SURFLON (registered trademark)S-243 0.15% by mass

(a fluorine-based surfactant containing a perfluoro group, refractive index: 1.35, manufactured by AGC SEIMI CHEMICAL CO., LTD.)
Adipic acid the amount listed in Table 1

(specific polycarboxylic acid, polycarboxylic acid having a partial structure that links carbon atoms in two carboxy groups and has four linearly bonded atoms, molecular weight: 146)
Ion exchange water remaining amount set such that the total amount of the composition was 100% by mass

### Examples 2 to 5

Each ink of Examples 2 to 5 was prepared in the same manner as in Example 1 except that the “adipic acid” in the “—composition of ink—” of Example 1 was changed to the polycarboxylic acid listed in Table 1.

### Examples 6 and 7

Each ink of Examples 6 and 7 was prepared in the same manner as in Example 4 except that the metal dispersion liquid containing the metal particles listed in Table 1 was prepared by quickening the timing of addition of “5.0 L of a 1N (mol/L) sodium hydroxide (NaOH) aqueous solution” during the “—preparation of metal particle-forming liquid—” in Example 4.

### Example 8

A gold dispersion liquid was prepared as the metal dispersion liquid.

3 L of 0.002 M sodium citrate was added to a stainless steel pot and heated to 50° C. while being stirred in a water bath. A 2 L aqueous solution containing 0.0013 M tetrachloroauric (III) acid (HAuCl4) and 0.008 M cetylmethylammonium bromide was also heated and then poured into the sodium citrate aqueous solution after the temperature thereof reached 50° C. The resulting solution was stirred at 50° C. for 30 minutes, heated to 80° C., and allowed to react for 10 minutes. The liquid temperature was decreased to 40°, and the total amount of the same gelatin aqueous solution at 40° C. as the solution prepared in Example 1 was added to the reaction solution.

In the manner described above, a metal particle-forming liquid was obtained.

800 g of the metal particle-forming liquid prepared in the above-described manner was collected in a centrifuge tube, a centrifugation operation was performed thereon using a centrifuge (himacCR22GIII, angle rotor: R9A, manufactured by Hitachi Koki Co., Ltd.) under conditions of 35° C. at 9000 rpm for 60 minutes, and 784 g of the supernatant liquid was disposed of. 0.2 mmol/L of a NaOH aqueous solution was added to the remaining solid (in other words, a solid containing metal particles and gelatin) such that the total amount thereof was set to 40 g, and the solution was stirred by hand using a stirring rod, thereby obtaining a crude dispersion liquid X.

By performing the same operation as described above, 120 crude dispersion liquids X were prepared. All of these prepared crude dispersion liquids X (in other words, 4800 g in total) were added to a tank made of SUS316L and mixed. Next, 10 mL of a 10 g/L solution (as the solvent, a mixed solution of methanol and ion exchange water at a volume ratio of 1:1 was used) of Pluronic 31R1 (nonionic surfactant, manufactured by BASF SE) was further added thereto.

Next, a batch type dispersing treatment was performed on the mixture of the crude dispersion liquids X in the tank at 9000 rpm for 120 minutes using an automixer 20 type (manufactured by PRIMIX Corporation) (a homomixer MARKII as a stirring unit). The liquid temperature during the dispersing treatment was maintained at 50° C.

In the above-described manner, a metal dispersion liquid (a so-called silver dispersion liquid) was prepared.

Further, an ink of Example 8 was prepared in the same manner as in Example 4 except that the metal dispersion liquid prepared in the above-described manner was used as the metal dispersion liquid used in the “2. Preparation of ink for ink jet recording” in place of the silver dispersion liquid in Example 4.

### Examples 9 to 12

Each ink of Examples 9 to 12 was prepared in the same manner as in Example 4 except that the content of “azelain” in the “—composition of ink—” of Example 4 was changed to the content listed in Table 1.

### Example 13

An ink of Example 13 was prepared in the same manner as in Example 4 except that the metal dispersion liquid was prepared by reducing the amount of the “0.10 g/L silver nitrate aqueous solution” added to the liquid to which the sodium borohydride aqueous solution had been added to “1.2 L” from “13 L” during the “—preparation of metal particle-forming liquid—” in Example 4.

### Example 14

An ink of Example 14 was prepared in the same manner as in Example 4 except that the metal dispersion liquid was prepared by reducing the amount of the “0.10 g/L silver nitrate aqueous solution” added to the liquid to which the sodium borohydride aqueous solution had been added to “0.3 L” from “13 L” during the “—preparation of metal particle-forming liquid—” in Example 4.

### Examples 15 and 16

Each ink of Examples 15 and 16 was prepared in the same manner as in Example 4 except that the content of “gelatin” in the “—composition of ink—” of Example 4 was changed to the content listed in Table 1.

### Example 17

An ink of Example 17 was prepared in the same manner as in Example 4 except that the “gelatin” in the “—composition of ink—” of Example 4 was changed to “polyethyleneimine (a specific water-soluble resin, a water-soluble resin containing an amino group)”. Further, the polyethyleneimine in the “—preparation of metal particle-forming liquid—” was prepared as a 12 mass % aqueous solution and then used.

### Example 17

An ink of Example 18 was prepared in the same manner as in Example 4 except that the “gelatin” in the “—composition of ink—” of Example 4 was changed to “polyvinylpyrrolidone (PVP) (a specific water-soluble resin, a water-soluble resin containing an amino group)”.

Further, the PVP in the “—preparation of metal particle-forming liquid—” was prepared as a 12 mass % aqueous solution and then used.

### Example 18

An ink of Example 19 was prepared in the same manner as in Example 4 except that the “gelatin” in the “—composition of ink—” of Example 4 was changed to “polyacrylic acid (a specific water-soluble resin, a water-soluble resin containing a carboxyl group, weight-average molecular weight: 25000, manufactured by Wako Pure Chemical Industries, Ltd.)”.

Further, the polyacrylic acid in the “—preparation of metal particle-forming liquid—” was prepared as a 12 mass % aqueous solution and then used.

### Comparative Example 1

An ink of Comparative Example 1 was prepared in the same manner as in Example 4 except that the “azelaic acid” in the “—composition of ink—” of Example 4 was changed to “glutaric acid (comparative carboxylic acid, polycarboxylic acid having a partial structure that connects carbon atoms in two carboxy groups to each other and has three linearly bonded atoms, molecular weight: 132)”.

### Comparative Example 2

An ink of Comparative Example 2 was prepared in the same manner as in Example 4 except that the “azelaic acid” in the “—composition of ink—” of Example 4 was changed to “citric acid (comparative carboxylic acid, polycarboxylic acid having a partial structure that connects carbon atoms in two carboxy groups to each other and has three linearly bonded atoms, molecular weight: 192)”.

### Comparative Example 3

An ink of Comparative Example 3 was prepared in the same manner as in Example 4 except that the metal dispersion liquid containing the metal particles listed in Table 1 was prepared by quickening the timing of addition of “5.0 L of a 1N (mol/L) sodium hydroxide (NaOH) aqueous solution” during the “—preparation of metal particle-forming liquid—” in Example 4.

### Comparative Example 4

An ink of Comparative Example 4 was prepared in the same manner as in Example 4 except that “azelaic acid” was not used in Example 4.

### Comparative Example 5

An ink of Comparative Example 5 was prepared in the same manner as in Example 4 except that “gelatin” was not used in Example 4.

### Comparative Example 6

An ink of Comparative Example 6 was prepared in the same manner as in Example 4 except that the “azelaic acid” in the “—composition of ink—” of Example 4 was changed to “propionic acid (comparative carboxylic acid, monovalent carboxylic acid, molecular weight: 74)”.

### Comparative Example 7

An ink of Comparative Example 7 was prepared in the same manner as in Example 4 except that the “azelaic acid” in the “—composition of ink—” of Example 4 was changed to “butanoic acid (comparative carboxylic acid, monovalent carboxylic acid, molecular weight: 88)”.

### Comparative Example 8

An ink of Comparative Example 8 was prepared in the same manner as in Example 4 except that the “gelatin” in the “—composition of ink—” of Example 4 was changed to “polyvinyl alcohol (PVA) (trade name: Poly(vinyl Alcohol), average degree of polymerization: 1750±50, manufactured by Tokyo Chemical Industry Co., Ltd.)”.

Further, the polyvinyl alcohol in the “—preparation of metal particle-forming liquid—” was prepared as a 12 mass % aqueous solution and then used.

In addition, the shape and the size of the metal particles contained in the ink can be adjusted according to the following method.

For example, in the “—preparation of metal particle-forming liquid—” at the time of preparation of the metal dispersion liquid, the thickness was increased and the average aspect ratio was decreased by quickening the timing of addition of “1 N (mol/L) of a 5.0 L sodium hydroxide (NaOH) aqueous solution” (for example, “1 N (mol/L) of a 5.0 L sodium hydroxide (NaOH) aqueous solution” was added before the change in pH of the liquid to which the silver sulfite white precipitate mixed solution had been added was stopped). Further, the average equivalent circle diameter of the metal particles to be formed was further increased and the average aspect ratio was further increased by reducing the amount of “0.10 g/L of a 13 L silver nitrate aqueous solution” to be added.

—Shape and Size of Metal Particles Contained in Ink—

The shape and the size (specifically, the average equivalent circle diameter, the average thickness, and the average aspect ratio) of the metal particles contained in the ink were confirmed using the same method as the method for the shape and the size of metal particles contained in the metal dispersion liquid. The shape and the size (specifically, the average equivalent circle diameter and the average aspect ratio) of the metal particles contained in the ink are listed in Table 1 and Table 2.

TABLE 1

| | Carboxylic acid | | | | | | |
|---|---|---|---|---|---|---|---|
| | | | Number of linearly | | | | |
| | | | bonded atoms of | | Content | | |
| | | | partial structure | | (proportion in | | |
| | Specific | Comparative | connecting carbon | | total amount of | Metal particles | |
| | polycarboxylic | carboxylic | atoms in two | Molecular | metal particles) | Kind of | |
| | acid | acid | carboxy groups | weight | [% by mass] | metal | Shape |
| Example 1 | Adipic acid | — | 4 | 146 | 1 | Silver | Tabular |
| Example 2 | Pimelic acid | — | 5 | 160 | 1 | Silver | Tabular |
| Example 3 | Suberic acid | — | 6 | 174 | 1 | Silver | Tabular |
| Example 4 | Azelaic acid | — | 7 | 188 | 1 | Silver | Tabular |
| Example 5 | Sebacic acid | — | 8 | 202 | 1 | Silver | Tabular |
| Example 6 | Azelaic acid | — | 7 | 188 | 1 | Silver | Tabular |
| Example 7 | Azelaic acid | — | 7 | 188 | 1 | Silver | Tabular |
| Example 8 | Azelaic acid | — | 7 | 188 | 1 | Gold | Tabular |
| Example 9 | Azelaic acid | — | 7 | 188 | 0.01 | Silver | Tabular |
| Example 10 | Azelaic acid | — | 7 | 188 | 0.1 | Silver | Tabular |
| Example 11 | Azelaic acid | — | 7 | 188 | 10 | Silver | Tabular |
| Example 12 | Azelaic acid | — | 7 | 188 | 15 | Silver | Tabular |
| Example 13 | Azelaic acid | — | 7 | 188 | 1 | Silver | Tabular |
| Example 14 | Azelaic acid | — | 7 | 188 | 1 | Silver | Tabular |
| Example 15 | Azelaic acid | — | 7 | 188 | 1 | Silver | Tabular |
| Example 16 | Azelaic acid | — | 7 | 188 | 1 | Silver | Tabular |
| Example 17 | Azelaic acid | — | 7 | 188 | 1 | Silver | Tabular |
| Example 18 | Azelaic acid | — | 7 | 188 | 1 | Silver | Tabular |
| Example 19 | Azelaic acid | — | 7 | 188 | 1 | Silver | Tabular |

| | | | | Water-soluble resin | |
|---|---|---|---|---|---|
| | Metal particles | | | (dispersant) | |
| | Average | | | | Content |
| | equivalent | | | | (proportion in |
| | circle | Average | Content | | total amount of |
| | diameter | aspect | [% by | | metal particles) |
| | [nm] | ratio | mass] | Type | [% by mass] |
| Example 1 | 120 | 20 | 2 | Gelatin | 10 |
| Example 2 | 120 | 20 | 2 | Gelatin | 10 |
| Example 3 | 120 | 20 | 2 | Gelatin | 10 |
| Example 4 | 120 | 20 | 2 | Gelatin | 10 |
| Example 5 | 120 | 20 | 2 | Gelatin | 10 |
| Example 6 | 100 | 12 | 2 | Gelatin | 10 |
| Example 7 | 40 | 5 | 2 | Gelatin | 10 |
| Example 8 | 120 | 12 | 2 | Gelatin | 10 |
| Example 9 | 120 | 20 | 2 | Gelatin | 10 |
| Example 10 | 120 | 20 | 2 | Gelatin | 10 |
| Example 11 | 120 | 20 | 2 | Gelatin | 10 |
| Example 12 | 120 | 20 | 2 | Gelatin | 10 |
| Example 13 | 600 | 40 | 2 | Gelatin | 10 |
| Example 14 | 1000 | 50 | 2 | Gelatin | 10 |
| Example 15 | 120 | 20 | 2 | Gelatin | 30 |
| Example 16 | 120 | 20 | 2 | Gelatin | 40 |
| Example 17 | 120 | 20 | 2 | Polyethyleneimine | 10 |
| Example 18 | 120 | 20 | 2 | PVP | 10 |
| Example 19 | 120 | 20 | 2 | Polyacrylic acid | 10 |

TABLE 2

| | Carboxylic acid | | | | | | |
|---|---|---|---|---|---|---|---|
| | | | Number of linearly | | | | |
| | | | bonded atoms of | | Content | | |
| | | | partial structure | | (proportion in | | |
| | Specific | Comparative | connecting carbon | | total amount of | Metal particles | |
| | polycarboxylic | carboxylic | atoms in two | Molecular | metal particles) | Kind of | |
| | acid | acid | carboxy groups | weight | [% by mass] | metal | Shape |
| Comparative | — | Glutaric acid | 3 | 132 | 1 | Silver | Tabular |
| Example 1 | | | | | | | |
| Comparative | — | Citric acid | 3 | 192 | 1 | Silver | Tabular |
| Example 2 | | | | | | | |
| Comparative | Azelaic acid | — | 7 | 188 | 1 | Silver | Tabular |
| Example 3 | | | | | | | |
| Comparative | — | — | — | — | — | Silver | Tabular |
| Example 4 | | | | | | | |
| Comparative | Azelaic acid | — | 7 | 188 | 1 | Silver | Tabular |
| Example 5 | | | | | | | |
| Comparative | — | Propionic acid | — | 74 | 1 | Silver | Tabular |
| Example 6 | | (monovalent | | | | | |
| | | carboxylic | | | | | |
| | | acid) | | | | | |
| Comparative | — | Butanoic acid | — | 88 | 1 | Silver | Tabular |
| Example 7 | | (monovalent | | | | | |
| | | carboxylic | | | | | |
| | | acid) | | | | | |
| Comparative | Azelaic acid | — | 7 | 188 | 1 | Silver | Tabular |
| Example 8 | | | | | | | |

| | | | | Water-soluble resin | |
|---|---|---|---|---|---|
| | Metal particles | | | (dispersant) | |
| | Average | | | | Content |
| | equivalent | | | | (proportion in |
| | circle | Average | Content | | total amount of |
| | diameter | aspect | [% by | | metal particles) |
| | [nm] | ratio | mass] | Type | [% by mass] |
| Comparative | 120 | 20 | 2 | Gelatin | 10 |
| Example 1 | | | | | |
| Comparative | 120 | 20 | 2 | Gelatin | 10 |
| Example 2 | | | | | |
| Comparative | 60 | 1 | 2 | Gelatin | 10 |
| Example 3 | | | | | |
| Comparative | 120 | 20 | 2 | Gelatin | 10 |
| Example 4 | | | | | |
| Comparative | 120 | 20 | 2 | — | — |
| Example 5 | | | | | |
| Comparative | 120 | 20 | 2 | Gelatin | 10 |
| Example 6 | | | | | |
| Comparative | 120 | 20 | 2 | Gelatin | 10 |
| Example 7 | | | | | |
| Comparative | 120 | 20 | 2 | PVA | 10 |
| Example 8 | | | | | |

In Table 1 and Table 2, “-” indicates that the corresponding one is not available.

[Evaluation]

1. Thixotropic Properties of Ink

The thixotropic properties of the ink were evaluated using a rheometer (HAAKE MARS (registered trademark) III, manufactured by Thermo Fisher Scientific). The viscosity was measured by logarithmically accelerating the shear rate from 0.1 [unit: l/s] to 1000 [unit: l/s] in five steps under a condition of an ambient temperature of 25° C. using a cone plate (cone radius: 60 mm). In this measurement, the thixotropic properties of the ink were evaluated according to the following evaluation standards based on the ratio (η1/η2) of a viscosity η1 at a shear rate of 10 [unit: l/s] to a viscosity η2 at a shear rate of 1000 [unit: l/s]. The evaluation results are listed in Table 3.

In a case where the evaluation result was “5”, “4”, or “3”, it was determined that the ink was suitable for practical use.

˜Evaluation Standards˜

5: 2.5≤η1/η2

4: 2.0≤η1/η2<2.5

3: 1.5≤η1/η2<2.0

2: 1.2≤η1/η2<1.5

1: η1/η2<1.2

2. Sharpness of Image

A cartridge (Dimatix Materials Cartridge (Jetpowerd)) dedicated to an ink jet printer (DMP-2831, manufactured by FUJIFILM DIMATIX, Inc.) was filled with the ink prepared in the above-described manner. Next, the dedicated cartridge filled with the ink was set in an ink jet printer. The dedicated cartridge has a structure in which the ink cartridge and the ink jet head are integrated with each other. The ink jet head has nozzles with a nozzle diameter of 21.5 μm and the number of nozzles thereof is 16.

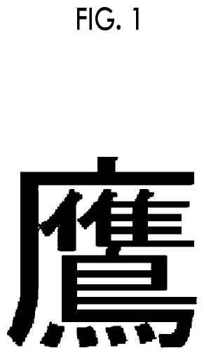

Next, the ink was jetted onto glossy paper (Kassai (registered trademark) photofinishing product Pro, ink jet paper, manufactured by Fujifilm Corporation) serving as a base material at room temperature under jetting conditions of an ink droplet amount of 2.8 μL, a jetting frequency of 25.5 kHz, and a resolution of 1200 dpi×1200 dpi (dot per inch; the same applies hereinafter), the character image shown in FIG. 1 was recorded on the glossy paper in sizes of 3 points, 4 points, and 5 points, and the images were visually observed. Further, the sharpness of the images were evaluated based on the following evaluation standards. The evaluation results are listed in Table 3.

In a case where the evaluation result was “5” or “4”, it was determined that the ink was suitable for practical use.

˜Evaluation Standards˜

5: Interference between adjacent liquid droplets was not found, and the character images in all sizes of 3 points, 4 points, and 5 points were able to be clearly read.

4: Interference between adjacent liquid droplets was found, but the character images in all sizes of 3 points, 4 points, and 5 points were able to be read.

3: Interference between adjacent liquid droplets occurred, and the character image in a size of 3 points was not able to be read.

2: Interference between adjacent liquid droplets occurred, and the character image in a size of 4 points was not able to be read.

1: Interference between adjacent liquid droplets occurred, and the character image in a size of 5 points was not able to be read.

3. Specular Glossiness of Image

—Image Recording—

A cartridge (Dimatix Materials Cartridge (Jetpowerd)) dedicated to an ink jet printer (DMP-2831, manufactured by FUJIFILM DIMATIX, Inc.) was filled with the ink prepared in the above-described manner. Next, the dedicated cartridge filled with the ink was set in an ink jet printer. The dedicated cartridge has a structure in which the ink cartridge and the ink jet head are integrated with each other. The ink jet head has nozzles with a nozzle diameter of 21.5 μm and the number of nozzles thereof is 16.

Next, the ink was jetted onto glossy paper (Kassai (registered trademark) photofinishing product Pro, ink jet paper, manufactured by Fujifilm Corporation) serving as a base material at room temperature under jetting conditions of an ink droplet amount of 2.8 μL, a jetting frequency of 25.5 kHz, and a resolution of 1200 dpi×1200 dpi (dot per inch; the same applies hereinafter), and a solid image (length of 70 mm x width of 30 mm) was recorded on the glossy paper. After the solid image was recorded, the solid image was completely dried.

(1) Evaluation Based on Gloss Value

The 20° gloss value of the dried solid image was measured using a gloss watch (micro-TRI-gloss, manufactured by BYK-Chemie GmbH). Based on the obtained measured value of the 20° gloss value, the specular glossiness of the image was evaluated according to the following evaluation standards. The evaluation results are listed in Table 3.

As the 20° gloss value increases, this means that the specular glossiness of the image is excellent.

In a case where the evaluation result was “5”, “4”, or “3”, it was determined that the ink was suitable for practical use.

˜Evaluation Standards˜

5: The 20° gloss value was 800 or greater.

4: The 20° gloss value was 600 or greater and less than 800.

3: The 20° gloss value was 300 or greater and less than 600.

2: The 20° gloss value was 150 or greater and less than 300.

1: The 20° gloss value was less than 150.

(2) Sensory Evaluation

The specular glossiness of the image was evaluated by visually observing the dried solid image. The evaluation results are listed in Table 3.

The evaluation standards are as follows.

In a case where the evaluation result was “5”, “4”, or “3”, it was determined that the ink was suitable for practical use.

˜Evaluation Standards˜

5: The image had extremely excellent specular glossiness, and the reflected object was clearly seen like a mirror image.

4: The image had excellent specular glossiness, and the reflected image was able to be identified.

3: The image had specular glossiness, but the reflected object was not able to be identified.

2: The image had weak metallic tone gloss, but did not have specular glossiness, and thus an object was not reflected.

1: The image did not have gloss and was seen to be gray.

4. Tint of image

Using an ultraviolet-visible near infrared spectrophotometer (V-660, manufactured by JASCO Corporation), the reflection tint of specular reflection of the dried solid image was measured. The metric saturation c* was calculated from the obtained measured values of a* and b* based on Calculation Formula (a*²+b*²)^{1/2}. Based on the obtained value of the metric saturation c*, the tint of the image was evaluated according to the following evaluation standards. The evaluation results are listed in Table 3.

As the value of the metric saturation c* decreases, this indicates that the tint of the image is suppressed (that is, the image is an image with a neutral tint).

In a case where the evaluation result was “5”, “4”, or “3”, it was determined that the ink was suitable for practical use.

˜Evaluation Standards˜

5: c*<10

4: 10≤c*<15

3: 15≤c*<20

2: 20≤c*<25

1: 25≤c*

TABLE 3

| | Evaluation results | | | | |
|---|---|---|---|---|---|
| | | | Specular | | |
| | | Sharp- | glossiness of image | | |
| | Thixotropic | ness of | 20° gloss | Sensory | Tint of |
| | properties | image | value | evaluation | image |
| Example 1 | 4 | 4 | 5 | 5 | 5 |
| Example 2 | 4 | 4 | 5 | 5 | 5 |
| Example 3 | 4 | 4 | 5 | 5 | 5 |
| Example 4 | 5 | 5 | 5 | 5 | 5 |
| Example 5 | 5 | 5 | 5 | 5 | 5 |
| Example 6 | 5 | 5 | 4 | 4 | 4 |
| Example 7 | 5 | 5 | 3 | 3 | 3 |
| Example 8 | 5 | 5 | 3 | 3 | 3 |
| Example 9 | 5 | 5 | 5 | 5 | 5 |
| Example 10 | 5 | 5 | 5 | 5 | 5 |
| Example 11 | 5 | 5 | 5 | 5 | 5 |
| Example 12 | 5 | 5 | 4 | 4 | 4 |
| Example 13 | 5 | 5 | 4 | 4 | 4 |
| Example 14 | 5 | 5 | 3 | 3 | 3 |
| Example 15 | 5 | 5 | 4 | 4 | 4 |
| Example 16 | 5 | 5 | 4 | 4 | 3 |
| Example 17 | 4 | 4 | 4 | 4 | 4 |
| Example 18 | 4 | 4 | 4 | 4 | 4 |
| Example 19 | 3 | 4 | 5 | 5 | 5 |
| Comparative | 2 | 3 | 5 | 5 | 5 |
| Example 1 | | | | | |
| Comparative | 2 | 3 | 5 | 5 | 5 |
| Example 2 | | | | | |
| Comparative | 2 | 3 | 2 | 2 | 2 |
| Example 3 | | | | | |
| Comparative | 2 | 3 | 5 | 5 | 5 |
| Example 4 | | | | | |
| Comparative | 2 | 3 | 3 | 3 | 3 |
| Example 5 | | | | | |
| Comparative | 2 | 3 | 3 | 3 | 3 |
| Example 6 | | | | | |
| Comparative | 2 | 3 | 5 | 5 | 5 |
| Example 7 | | | | | |
| Comparative | 2 | 3 | 5 | 5 | 5 |
| Example 8 | | | | | |

As listed in Table 3, each ink of Examples 1 to 19 which contained tabular metal particles, a water-soluble resin having at least one functional group selected from the group consisting of a carboxy group, an amino group, and a thiol group, a polycarboxylic acid having a partial structure which connected carbon atoms in two carboxy groups to each other and had four or more linearly bonded atoms, or a salt thereof, and water had thixotropic properties. Further, according to each ink of Examples 1 to 19, the landing interference of the ink was suppressed, and thus a sharp image was able to be recorded. Further, according to each ink of Examples 1 to 19, an image having specular glossiness was able to be recorded. Further, an image recorded using any ink of Examples 1 to 19 had a suppressed tint.

Meanwhile, each ink of Comparative Examples 1 and 2 which contained tabular metal particles, a water-soluble resin having at least one functional group selected from the group consisting of a carboxy group, an amino group, and a thiol group, a polycarboxylic acid, and water and in which the number of linearly bonded atoms in the partial structure that connected carbon atoms in two carboxy groups in the polycarboxylic acid was three had significantly degraded thixotropic properties. According to each ink of Comparative Examples 1 and 2, the landing interference of the ink occurred, and thus the sharpness of the recorded image was degraded.

The ink of Comparative Example 3 which contained metal particles, a water-soluble resin having at least one functional group selected from the group consisting of a carboxy group, an amino group, and a thiol group, a polycarboxylic acid having a partial structure which connected carbon atoms in two carboxy groups to each other and had four or more linearly bonded atoms, and water and in which the metal particles were circular had significantly degraded thixotropic properties. According to the ink of Comparative Example 3, the landing interference of the ink occurred, and thus the sharpness of the recorded image was degraded. Further, the image recorded using the ink of Comparative Example 3 was significantly tinted and did not have specular glossiness.

The ink of Comparative Example 4 which contained tabular metal particles, a water-soluble resin having at least one functional group selected from the group consisting of a carboxy group, an amino group, and a thiol group, and water and did not contain a polycarboxylic acid having a partial structure which connected carbon atoms in two carboxy groups to each other and had four or more linearly bonded atoms had significantly degraded thixotropic properties. According to the ink of Comparative Example 3, the landing interference of the ink occurred, and thus the sharpness of the recorded image was degraded.

The ink of Comparative Example 5 which contained tabular metal particles, a polycarboxylic acid having a partial structure which connected carbon atoms in two carboxy groups to each other and had four or more linearly bonded atoms, and water and did not contain a water-soluble resin having at least one functional group selected from the group consisting of a carboxy group, an amino group, and a thiol group had significantly degraded thixotropic properties. According to the ink of Comparative Example 5, the landing interference of the ink occurred, and thus the sharpness of the recorded image was degraded. Further, the image recorded using the ink of Comparative Example 5 had degraded specular glossiness and was also tinted compared to an image recorded using an ink (for example, the ink of Example 4) containing a water-soluble resin having at least one functional group selected from the group consisting of a carboxy group, an amino group, and a thiol group.

The ink of Comparative Example 6 which contained propionic acid as a monovalent carboxylic acid in place of the polycarboxylic acid having a partial structure which connected carbon atoms in two carboxy groups to each other and had four or more linearly bonded atoms had significantly degraded thixotropic properties. Further, according to the ink of Comparative Example 6, the landing interference of the ink occurred, and thus the sharpness of the recorded image was degraded. Further, the image recorded using the ink of Comparative Example 6 had degraded specular glossiness and was also tinted compared to an image recorded using an ink (for example, the ink of Example 4) containing the polycarboxylic acid having a partial structure which connected carbon atoms in two carboxy groups to each other and had four or more linearly bonded atoms.

The ink of Comparative Example 6 which contained butanoic acid as a monovalent carboxylic acid in place of the polycarboxylic acid having a partial structure which connected carbon atoms in two carboxy groups to each other and had four or more linearly bonded atoms had significantly degraded thixotropic properties. Further, according to the ink of Comparative Example 7, the landing interference of the ink occurred, and thus the sharpness of the recorded image was degraded.

The ink of Comparative Example 8 which contained a water-soluble resin free from the functional groups of a carboxy group, an amino group, and a thiol group in place of the water-soluble resin having at least one functional group selected from the group consisting of a carboxy group, an amino group, and a thiol group had significantly degraded thixotropic properties.

The entirety of the disclosure of JP2017-158890 filed on Aug. 21, 2017 is incorporated in the present specification by reference.

All documents, patent applications, and technical standards described in the present specification are incorporated herein by reference to the same extent as in a case of being specifically and individually noted that individual documents, patent applications, and technical standards are incorporated by reference.

What is claimed is:

1. A metal dispersion liquid comprising:
tabular metal particles;
a water-soluble resin which contains at least one functional group selected from the group consisting of a carboxy group, an amino group, and a thiol group;
a polycarboxylic acid having a partial structure which connects carbon atoms in two carboxy groups to each other and has four or more linearly bonded atoms, or a salt thereof; and
water.

2. The metal dispersion liquid according to claim 1,
wherein the tabular metal particles contain at least one metal element selected from the group consisting of silver, gold, and platinum.

3. The metal dispersion liquid according to claim 1,
wherein the tabular metal particles contain silver.

4. The metal dispersion liquid according to claim 1,
wherein the tabular metal particles have an average aspect ratio of 5 to 100, which is a ratio of an average equivalent circle diameter to an average thickness.

5. The metal dispersion liquid according to claim 1,
wherein the tabular metal particles have an average aspect ratio of 12 to 100, which is the ratio of the average equivalent circle diameter to the average thickness.

6. The metal dispersion liquid according to claim 1,
wherein the tabular metal particles have an average aspect ratio of 20 to 100, which is the ratio of the average equivalent circle diameter to the average thickness.

7. The metal dispersion liquid according to claim 1,
wherein a molecular weight of the polycarboxylic acid or the salt thereof is 120 or greater in terms of the polycarboxylic acid.

8. The metal dispersion liquid according to claim 1,
wherein the molecular weight of the polycarboxylic acid or the salt thereof is 160 or greater in terms of the polycarboxylic acid.

9. The metal dispersion liquid according to claim 1,
wherein the molecular weight of the polycarboxylic acid or the salt thereof is 180 or greater in terms of the polycarboxylic acid.

10. The metal dispersion liquid according to claim 1,
wherein a content of the polycarboxylic acid or the salt thereof is in a range of 0.001% by mass to 15% by mass with respect to a total amount of the tabular metal particles in terms of the polycarboxylic acid.

11. The metal dispersion liquid according to claim 1,
wherein an average equivalent circle diameter of the tabular metal particles is in a range of 50 nm to 600 nm.

12. The metal dispersion liquid according to claim 1,
wherein a content of the water-soluble resin is in a range of 0.1% by mass to 30% by mass with respect to the total amount of the tabular metal particles.

13. The metal dispersion liquid according to claim 1,
wherein the content of the polycarboxylic acid or the salt thereof is in a range of 0.001% by mass to 10% by mass with respect to the total amount of the tabular metal particles in terms of the polycarboxylic acid.

14. The metal dispersion liquid according to claim 1, which is used as an ink.

15. The metal dispersion liquid according to claim 14, which is used for ink jet recording.

16. An image recording method comprising:
applying the metal dispersion liquid according to claim 1 onto a base material using an ink jet method.

17. A recorded object comprising:
a base material; and
an image which is disposed on the base material and contains tabular metal particles and a water-soluble resin containing at least one functional group selected from the group consisting of a carboxy group, an amino group, and a thiol group,
wherein at least one of the base material or the image contains a polycarboxylic acid having a partial structure which connects carbon atoms in two carboxy groups to each other and has four or more linearly bonded atoms, or a salt thereof.

18. The metal dispersion liquid according to claim 1,
wherein the tabular metal particles have an average aspect ratio of 12 to 100, which is the ratio of the average equivalent circle diameter to the average thickness, and
wherein the content of the polycarboxylic acid or the salt thereof is in a range of 0.001% by mass to 10% by mass with respect to the total amount of the tabular metal particles in terms of the polycarboxylic acid.

19. A metal dispersion liquid comprising:
tabular metal particles;
a water-soluble resin which contains at least one functional group selected from the group consisting of a carboxy group, an amino group, and a thiol group;
a polycarboxylic acid having a partial structure which connects carbon atoms in two carboxy groups to each other and has four or more linearly bonded atoms, or a salt thereof; and
water,
wherein the tabular metal particles contain silver,
wherein the tabular metal particles have an average aspect ratio of 20 to 100, which is the ratio of the average equivalent circle diameter to the average thickness,
wherein the average equivalent circle diameter of the tabular metal particles is in a range of 50 nm to 600 nm,
wherein a content of the water-soluble resin is in a range of 0.1% by mass to 30% by mass with respect to the total amount of the tabular metal particles,
wherein the molecular weight of the polycarboxylic acid or the salt thereof is 180 or greater in terms of the polycarboxylic acid, and
wherein the content of the polycarboxylic acid or the salt thereof is in a range of 0.001% by mass to 10% by mass with respect to the total amount of the tabular metal particles in terms of the polycarboxylic acid.
